(19) United States
(12) Patent Application Publication
(10) Pub. No.: US 2002/0147793 A1
(43) Pub. Date: Oct. 10, 2002

(54) Information providing server and method of searching for information requested by user based on search term and providing user with information

(75) Inventor: Tsukasa Ooishi, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/969,731

(22) Filed: Oct. 4, 2001

(30) Foreign Application Priority Data
Mar. 27, 2001 (JP) 2001-090270 (P)

(51) Int. Cl. G06F 15/16; G06F 7/00

(52) U.S. Cl. 709/219; 707/10; 707/3

(57) ABSTRACT

An information providing method includes the steps of preparing technical information, retrieving words and compound terms included in the prepared technical information, applying weights to the words and compound terms so that the weight of the compound term is greater than the sum of the weights of words included in the compound term, comparing words and compound terms included in a search term with words and compound terms included in the technical information upon receiving the search term from an information requester, and retrieving a weight by adding weights of matching words and compound terms, and transmitting retrieved data to the information requester.

### BACKGROUND OF THE INVENTION

1. Field of the Invention

The present invention relates to a system of providing information registered in a database by an information provider to an information requester. Particularly, the present invention relates to a system of providing information related to skill and technique.

2. Description of the Background Art

In accordance with the development of networks such as the Internet, a user can access a database through a network. Data that is required by the user is retrieved from a database as set forth in the following. Data as well as header data corresponding to each data are stored in a database. Based on the header of the data stored in the database and a search term input by a user who is requesting for information, the data with the header data that matches the search term is retrieved. The user can obtain required data through such retrieval.

In the case where there are a plurality of databases connected to the network, the user is not aware of which database is to be accessed to obtain the required data. Japanese Patent Laying-Open No. 11-250074 discloses an intermediary apparatus of providing a user with information in another database related to the currently searched information.

This intermediary apparatus notifies the user the search result of a plurality of databases connected through a network. This apparatus includes an acquisition circuit obtaining the contents information of a plurality of databases, a search circuit searching for information on a database designated by a user based on search data input by the user, an identify circuit identifying a relevant database storing information related to a search result of the search data based on the contents information, a generation circuit generating a search request on the relevant database identified by the identify circuit, and a notify circuit notifying the user a search result as to a search request generated by the generation circuit and the search result of search data input by the user.

According to this apparatus, the acquisition circuit obtains the contents information of the databases (what category of information is organized in the database, what item is stored in the database, and the like). The identify circuit identifies a relevant database storing information related to the search result of the search data input by the user, based on the contents information. The notify circuit notifies the user of the search result on the relevant database and the search result of the search data input by the user. Accordingly, the user can be notified of information related to the searched information in addition to the currently searching information by the apparatus. Thus, the potential search request of a user can be satisfied.

The information stored in a database includes information related to technique and skill (referred to as “technical information” hereinafter). The technical information differs from other information (for example, employee information with the items of place of employment, address, and hobby or the like corresponding to each name of personnel) in that it is difficult to be stored in a database that is developed based on predetermined items. For example, when a certain hobby is input with respect to the place of employment information, the name of the personnel having the input hobby stored is output as the search result. It is difficult to classify technical information based on items since technique is an abstract concept. The user could not easily obtain a satisfactory result of search on technical information even through the intermediary apparatus disclosed in the aforementioned publication.

### SUMMARY OF THE INVENTION

An object of the present invention is to provide an information providing server and method of properly searching for and providing the user with technical information.

Another object of the present invention is to provide an information providing server and method of easily and properly searching for and providing the user with technical information using a compound term having a plurality of words connected.

A further object of the present invention is to provide an information providing server and method of searching for technical information and providing the user that requires information with information, using a compound term having a plurality of words connected.

Still another object of the present invention is to provide an information providing server and method that can reliably collect the fee of providing technical information.

A still further object of the present invention is to provide an information providing server and method that can collect the fee of providing technical information at high price.

According to an aspect of the present invention, an information providing server is directed to providing information requested by a user. The information providing server includes a storage circuit storing information and a search term specified by the user to search for information, a first search circuit connected to the storage circuit to retrieve a word included in the information, a first weight storage circuit connected to the first search circuit to store a word retrieved by the first search circuit and the weight of the word, a first computation circuit connected to the storage circuit and the first weight storage circuit to retrieve a word matching a search term from the words included in the information and computing the level of coincidence between the information and a search term based on the weight of the word matching the search term, a determination circuit connected to the first computation circuit to determine information requested by the user based on the level of coincidence, and a supply circuit connected to the determination circuit to supply the user with the determined information.

The first search circuit retrieves words from information that includes an abstract concept such as technique. The retrieved words include a word that has a technically important meaning, and a general word. The first weight circuit stores a greater weight for a word that is more technically important. The first computation circuit retrieves a word that matches a search term from the words included in the information and determines the information required by the user based on the weight of the retrieved word. By assigning greater weight on a word of more technical importance, a high level of coincidence is output when that word is included in the search term. The information providing server can properly search for and provide the user with technical information.

Further preferably, the information providing server includes a second search circuit connected to the storage circuit to retrieve a compound term included in the information, and a second weight storage circuit connected to the first weight storage circuit and the second search circuit to store the compound term retrieved by the second search circuit and the weight of that compound term. The compound term has a plurality of words connected to form another new word. Weight is applied on a compound term so that a level of coincidence is obtained different from the level of coincidence computed based on the weights of the words included in the compound term. The information providing server further includes a second computation circuit connected to the storage circuit and the second weight storage circuit to retrieve a compound term matching a search term from the compound terms included in the information and computing the level of coincidence between the information and the search term based on the weight of the compound term matching the search term. The determination circuit includes a circuit that determines the information requested by the user based on the level of coincidence computed by the first computation circuit and the level of coincidence computed by the second computation circuit.

The second search circuit retrieves a compound term in the information that includes an abstract concept such as technique. There are some retrieved compound terms that have a greater technically important meaning compared to the case where the plurality of words in the compound term are simply arranged. For example, in the case of a compound term of “semiconductor memory device” that includes the three words of “semiconductor”, “memory” and “device”, the term “semiconductor memory device” has a more important meaning from the technical standpoint than “semiconductor”, “memory” and “device”. The compound term is assigned a weight greater than the level of coincidence computed based on the weights of the words included in the compound term. The second computation circuit retrieves a compound term that matches the search term from the compound terms included in the information and computes the level of coincidence between the information and the search term based on the weight of the retrieved compound term. By assigning a greater weight on a compound term with more technical importance, a high level of coincidence is obtained if that compound term is included in the search term. The information providing server can properly search for and provide the user with technical information.

Further preferably, the information includes data representing information and summary data representing the summary of the information. The information providing server further includes a communication circuit communicating with a user, and a transmission circuit connected to the determination circuit and communication circuit to transmit summary data included in the determined information to a plurality of users. The user receiving the summary data determines whether the determined information is required or not based on the summary data and sends, when determination is made that the information is required, request data to the server. The information providing server further includes a reception circuit connected to the communication circuit to receive the request data from a user. The supply circuit includes a circuit that supplies the user who has issued the request data with the determined information.

The user receiving summary data transmits request data to the server, when determination is made that data thereof is required. The information providing server can provide the information to only the user who requires the information.

The information providing server further includes a control circuit connected to and controlling the supply circuit so as to supply the user with the determined information when a predetermined condition is met.

The information providing server can provide information on the condition that a value for the supply of information is paid. Accordingly, the value for the supply of information can be collected reliably.

Further preferably, the request data includes fee data representing the amount intended to be paid by the user for supply of the determined information. The information providing server further includes a user determination circuit connected to the communication circuit to determine one user among a plurality of users who has transmitted the highest fee. The predetermined condition is the condition that the one user has paid the highest fee.

The information providing server can provide the user who has the highest payment as to the value for the supply of information with the information. The high value for supply of information can be reliably collected.

According to another aspect of the present invention, an information providing method is directed to providing information requested by a user. The information providing method includes the steps of preparing information and a search term specified by a user to retrieve information, retrieving a word included in the information, storing the word retrieved at the step of retrieving a word and the weight of the word, retrieving a word matching a search term from the words included in the information and computing the level of coincidence between the information and a search term based on the weight of the word matching the search term, determining information requested by the user based on the level of coincidence, and supplying the user with the determined information.

The step of retrieving a word retrieves a word included in the information. The retrieved word includes a word that has a technically important meaning and a general word. The step of storing a word and a weight of that word stores a greater weight as the term has a more technically important meaning. The step of determining information based on the level of coincidence retrieves a word matching the search term from the words in the information to determine the information requested by the user based on the weight of the retrieved word. By assigning greater weight on a word that has a technically important meaning, a high level of coincidence is obtained when that word is included in the search term. According to the information providing method, technical information can be properly retrieved and provided to the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an entire structure of a technical information intermediary system according to a first embodiment of the present invention.

FIG. 2 shows an appearance of a computer realizing the server of the first embodiment.

FIG. 3 is a control block diagram of a computer.

FIG. 4 shows a technical database stored in a hard disk of the server of the first embodiment.

FIGS. 5A-5C show keywords stored in the technical database of the first embodiment.

FIG. 6 shows storage request data transmitted from the computer of an information provider to the server according to the first embodiment.

FIG. 7 shows storage permit data transmitted from the server to the computer of an information provider according to the first embodiment.

FIG. 8 shows storage data transmitted from the computer of an information provider to the server according to the first embodiment.

FIG. 9 shows storage conclusion data transmitted from the server to the computer of an information provider according to the first embodiment.

FIG. 10 shows renewal inquiry data transmitted from the server to the computer of an information provider according to the first embodiment.

FIG. 11 shows renewal request data transmitted from the computer of an information provider to the server according to the first embodiment.

FIG. 12 shows renewal completion data transmitted from the server to the computer of an information provider according to the first embodiment.

FIG. 13 shows a discard completion data transmitted from the server to the computer of an information provider according to the first embodiment.

FIG. 14 shows search request data transmitted from the computer of an information requester to the server according to the first embodiment.

FIG. 15 shows search resultant data transmitted from the server to the computer of an information requester according to the first embodiment.

FIG. 16 shows select data transmitted from the computer of an information requester to the server according to the first embodiment.

FIG. 17 shows distribution fee data transmitted from the server to the computer of an information requester according to the first embodiment.

FIG. 18 shows distribution data transmitted from the server to the computer of an information requester according to the first embodiment.

FIG. 19 shows distribution completion data transmitted from the computer of an information requester to the server according to the first embodiment.

FIG. 20 shows assessment data transmitted from the computer of an information requester to the server.

FIG. 21 shows supply fee data transmitted from the server to the computer of an information provider according to the first embodiment.

FIG. 22 is a flow chart of a storage request process of the first embodiment.

FIGS. 23A and 23B are flow charts of a storage process of the first embodiment.

FIG. 24 is a flow chart of a storage renewal process of the first embodiment.

FIG. 25 is a flow chart of a storage renewal request process of the first embodiment.

FIGS. 26A and 26B are flow charts of a search request process of the first embodiment.

FIGS. 27A and 27B are flow charts of a search process of the first embodiment.

FIG. 28 is a flow chart of an assessment count process of the first embodiment.

FIG. 29 shows an information requester database stored in a hard disk of a server according to a second embodiment of the present invention.

FIG. 30 shows communication data transmitted from the server to the computer of an information requester according to the second embodiment.

FIG. 31 shows auction data transmitted from the computer of an information requester to the server according to the second embodiment.

FIG. 32 shows auction transition data transmitted from the server to the computer of an information requester according to the second embodiment.

FIG. 33 shows successful bid data transmitted from the server to the computer of an information requester according to the second embodiment.

FIG. 34 is a flow chart of a search request process according to the second embodiment.

FIG. 35 is a flow chart of a search process according to the second embodiment.

FIG. 36 is a flow chart of an auction participate process according to the second embodiment.

FIGS. 37A and 37B are flow charts of an auction process according to the second embodiment.

FIG. 38 is a flow chart of a successful bid postprocess according to the second embodiment.

### DESCRIPTION OF THE PREFERRED EMBODIMENTS

Embodiments of the present invention will be described hereinafter with reference to the drawings. The same components have the same reference characters allotted hereinafter. Their label and function are identical. Therefore, detailed description thereof will not be repeated.

### First Embodiment

Referring to FIG. 1, a technical information intermediary system according to a first embodiment of the present invention includes a computer 200 used by an information provider, a computer 300 used by an information requester, an accounting process server 400 processing fee payment, and a server 100 connected to computers 200 and 300 and accounting process server 400 through a network 500. The information provider provides technical information to server 100. The information requester requests server 100 for technical information. Accounting process server 400 processes the storage of technical information and payment of the fee for distribution.

Server 100 has a technical information intermediary function. Server 100 stores technical information received from information provider computer 200. The technical information intermediary function is directed to providing the information requester with technical information from the stored technical information that satisfies the request of the information requester.

The technical information intermediary function of server 100 is implemented by executing a predetermined program in a computer through a CPU (Central Processing Unit).

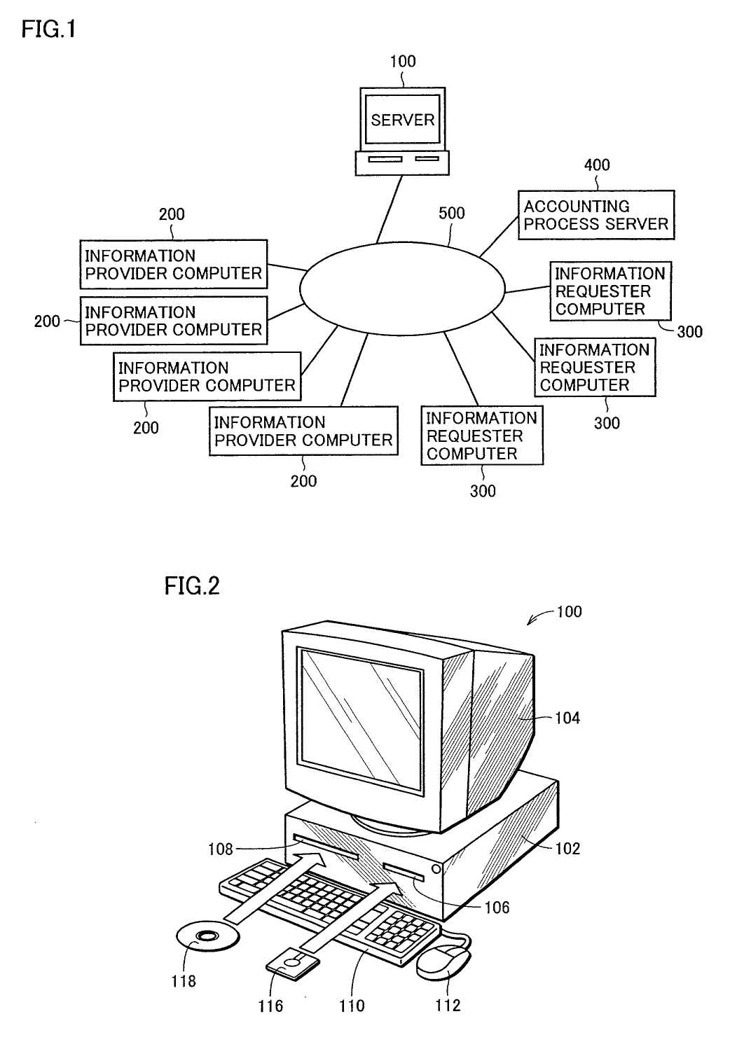

FIG. 2 shows an appearance of a computer system which is an example of server 100 realizing the technical information intermediary function. Referring to FIG. 2, this computer system includes a computer 102 with an FD (Flexible Disk) drive device 106 and a CD-ROM (Compact Disc-Read Only Memory) drive device 108, a monitor 104, a keyboard 110 and a mouse 112.

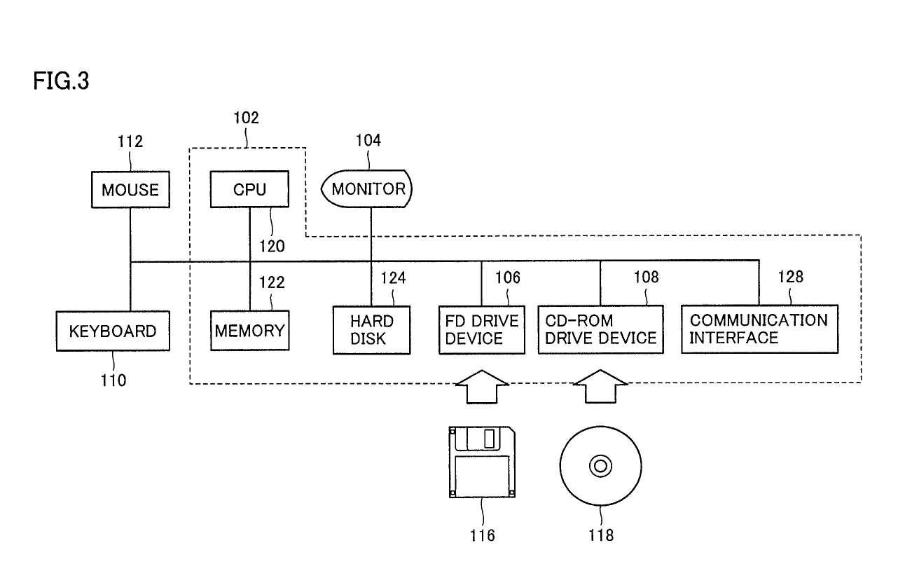

FIG. 3 shows a control block diagram of this computer system. As shown in FIG. 3, computer 102 includes, in addition to the aforementioned FD drive device 106 and CD-ROM drive device 108, a CPU (Central Processing Unit) 120, a memory 122, a hard disk 124, and a communication interface 128 to communicate with another computer, all interconnected through a bus. An FD 116 is set in FD drive device 106. A CD-ROM 118 is set in CD-ROM drive device 108. Predetermined programs corresponding to software are stored in FD 116 and CD-ROM 118.

Server 100 with the technical information intermediary function is realized by computer hardware and software executed by CPU 120. In general, such software is stored as a program in a storage medium such as FD 116 and CD-ROM 118 to be circulated. The software is read out from the recording medium by FD drive device 106 or CD-ROM drive device 108 and stored in hard disk 124. Then, the program is read from hard disk 124 into memory 122 to be executed by CPU 120.

The hardware itself of these computers is of the general type. The computer includes a control circuit including a CPU, a storage circuit, an input circuit, an output circuit and an OS (Operating System) with the environment to execute a program. The present invention operates such a computer as a technical information intermediary apparatus.

The operation of the computer shown in FIGS. 2 and 3 is well known, and detailed description thereof will not be repeated here.

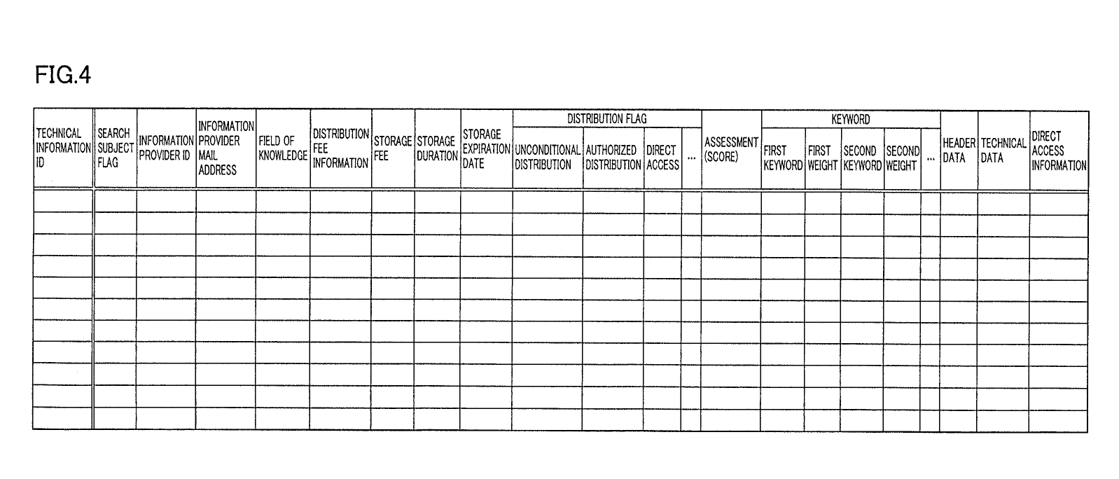

A technical database stored in hard disk 124 of server 100 will be described with reference to FIG. 4. The technical database includes, for each technical information ID (Identification), a search subject flag, an information provider ID, the mail address of the information provider, the field of knowledge, distribution fee information, storage fee, storage duration, storage expiration date, distribution flag, assessment, keyword, header data, technical data, and direct access information.

Technical information ID is the information to identify technical information stored in server 100. The search subject flag represents whether the technical information identified by technical information ID is to be taken as the subject of search by server 100. Information provider ID is the information to identify the user who has provided the technical information in server 100. The information provider mail address represents the mail address of the information provider. The field of knowledge represents the field of the knowledge included in the technical information. The distribution fee information represents the fee required to obtain the technical information. The storage fee is the fee required to store the technical data for a predetermined period in the technical database. The storage duration is the period of time the data is stored in the technical database according to the aforementioned storage fee. The storage expiration date is the date of the storage duration added from the time point of sensing payment of the storage fee by server 100.

The distribution flag represents the method of distributing technical data identified by the technical information ID. A distribution flag includes unconditional distribution, authorization distribution and direct access. In the case of unconditional distribution, technical data is distributed upon payment of the distribution fee following the search process by server 100. In the case of authorization distribution, technical data is distributed on the condition that a predetermined process is completed in server 100. The direct access is the flag used in the case where the information provider directly imparts technique to the information requester when the technique cannot be sufficiently represented by technical data.

Assessment represents evaluation of technical data transmitted from an information requester who has received technical data in the past. The information requester who regards the technical data as significant transmits assessment data to server 100. Upon reception of assessment data, server 100 adds one point to the assessment (score).

The keyword includes the words and compound terms included in the header data of the technical data identified through technical information ID, and the weight assigned to each of the words and compound terms. The keyword includes a first keyword, a first weight corresponding to the first keyword, a second keyword, and a second weight corresponding to the second keyword. The header data represents the summary of the technical data identified through the technical information ID. The technical data represents the contents of the technique provided from an information provider. The direct access information represents the way to contact the information provider. This information is used when the distribution flag indicates direct access.

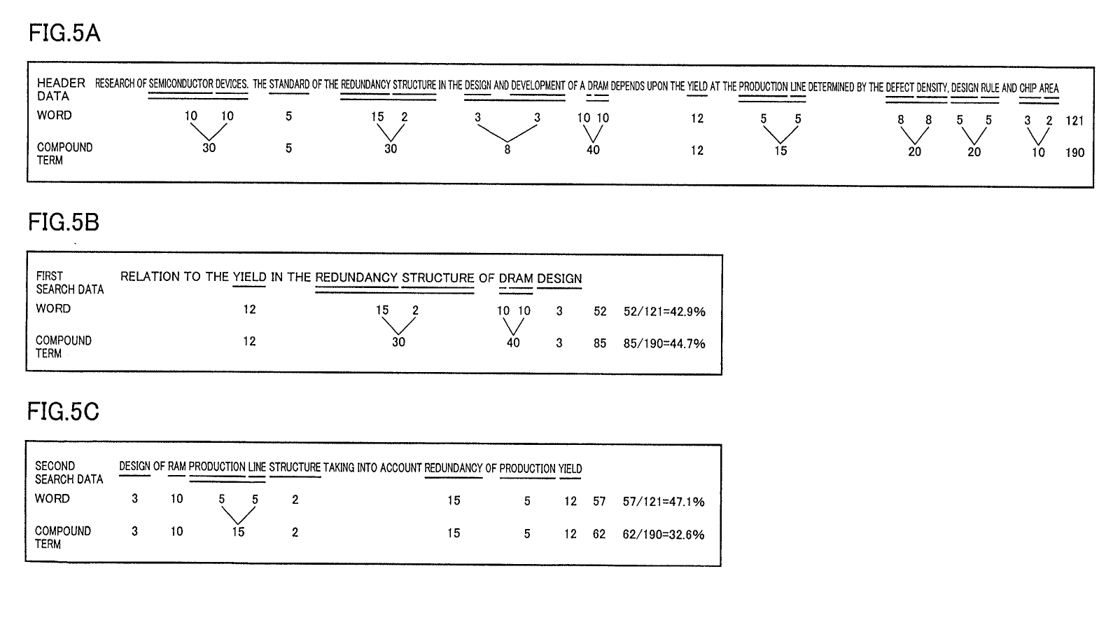

The keywords stored in the technical database (FIG. 4) will be described with reference to FIGS. 5A to 5C. As shown in FIG. 5A, the header data of the technical data is “Research of semiconductor devices. The standard of the redundancy structure in the design and development of a DRAM depends upon the yield at the production line determined by the defect density, design rule and the chip area.” In this case, server 100 retrieves the words such as “semiconductor”, “device”, “D”, “RAM”, “design”, “development”, redundancy”, “structure”, “standard”, and the like included in the header. Server 100 assigns a weight on each of the retrieved words.

As shown in FIG. 5A, “semiconductor” and “device” are both assigned the weight of “10”. Here, greater weight is applied as the term has a more technically important meaning according to the field of knowledge. All the retrieved words are assigned a weight and stored in the technical database (FIG. 4).

Server 100 retrieves compound terms included in the header. As shown in FIG. 5A, server 100 retrieves the compound terms of “semiconductor device”, “DRAM”, “design and development”, “redundancy structure” and the like included in the header data. Server 100 assigns each retrieved compound term a weight. In this case, a weight is applied so that the weight of a compound term that is technically important is greater than the sum of the weights applied to the respective words included in the compound term. For example, the compound term “semiconductor device” is assigned the weight “30” and compound term “DRAM” is assigned the weight “40”. A weight is applied to all the retrieved compound terms. The weight of the word “semiconductor” and the word “device” are assigned “10” and the weight of the compound term “semiconductor device” is assigned the weight “30”. Similarly, the weight of a compound term that is technically important is selected to be greater than the sum of the weights of respective words included in that compound term. In the case of the aforementioned header, the sum of the weights for the words is “121” whereas the sum of the weights for the compound terms is “190”.

Retrieval on the technical information with such header data according to the first and second search data shown in FIGS. 5B and 5C will be described here. It is assumed that the header data of FIG. 5A is output as the search result according to the first search data (FIG. 5B), but not output as the search result according to the second search data (FIG. 5C). The first search data is “Relation to the yield in the redundancy structure of DRAM design”, and the second search data is “Design of RAM production line structure taking into account redundancy of production yield”. Server 100 retrieves words and compound terms as to the first and second search data.

The case where server 100 uses the first search data to compute the level of coincidence between the first search data and header data will be described here. As shown in FIG. 5B, the weights of the words included in the first search data and that are retrieved from the header data are added, whereby the sum of 52 points is calculated. As to the compound terms included in the first search data, the weights of the compound terms retrieved from the header data are added to result in the sum of 85 points. The level of coincidence between the first retrieval data and the header data is calculated as 42.9% (52/121) and 44.7% (85/190) for the search based on the words and the compound terms, respectively. It is appreciated that retrieval by compound terms has a higher level of coincidence.

The case where server 100 uses the second search data to compute the level of coincidence between the second search data and header data will be described here. The second search data is the data to search for another technical data differing from the present header data. As shown in FIG. 5C, the level of coincidence between the second search data and the header data is calculated as 47.1% (57/121) and 32.6% (62/190) for the search based on the words and the compound terms, respectively. The retrieval based on compound terms exhibits a lower level of coincidence in the case of the second search data.

Thus, when technical data representing abstract concept is to be searched for according to header data and search data, a more precise search can be effected by retrieval based on compound terms.

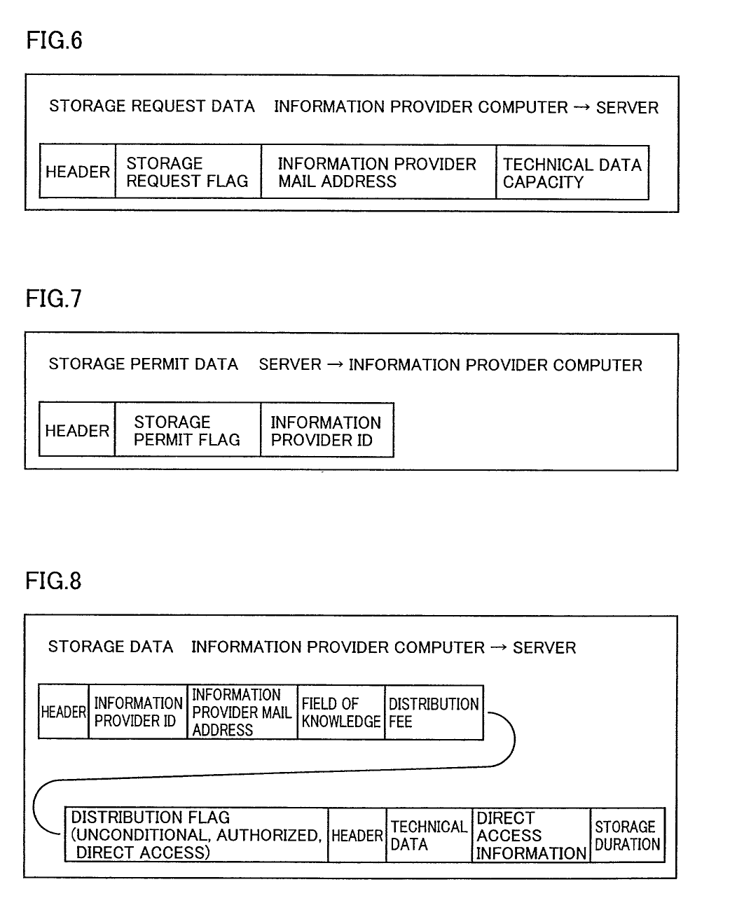

Storage request data transmitted from information provider computer 200 to server 100 will be described with reference to FIG. 6. The storage request data includes a header, a storage request flag, an information provider mail address, and technical data capacity. This storage request data is transmitted to server 100 before the information provider registers his/her own technical data to server 100.

Storage permit data transmitted from server 100 to information provider computer 200 will be described with reference to FIG. 7. The storage permit data includes a header, a storage permit flag, and an information provider ID. The information provider ID is an identification code assigned by server 100 to identify an information provider in server 100.

Storage data transmitted from information provider computer 200 to server 100 will be described with reference to FIG. 8. The storage data includes a header, an information provider ID, an information provider mail address, the field of knowledge, a distribution fee, a distribution flag (unconditional, authorized, direct access), a header, technical data, direct access information, and storage duration. Upon receiving this storage data from information provider computer 200, server 100 has this storage data stored in the technical database (FIG. 4).

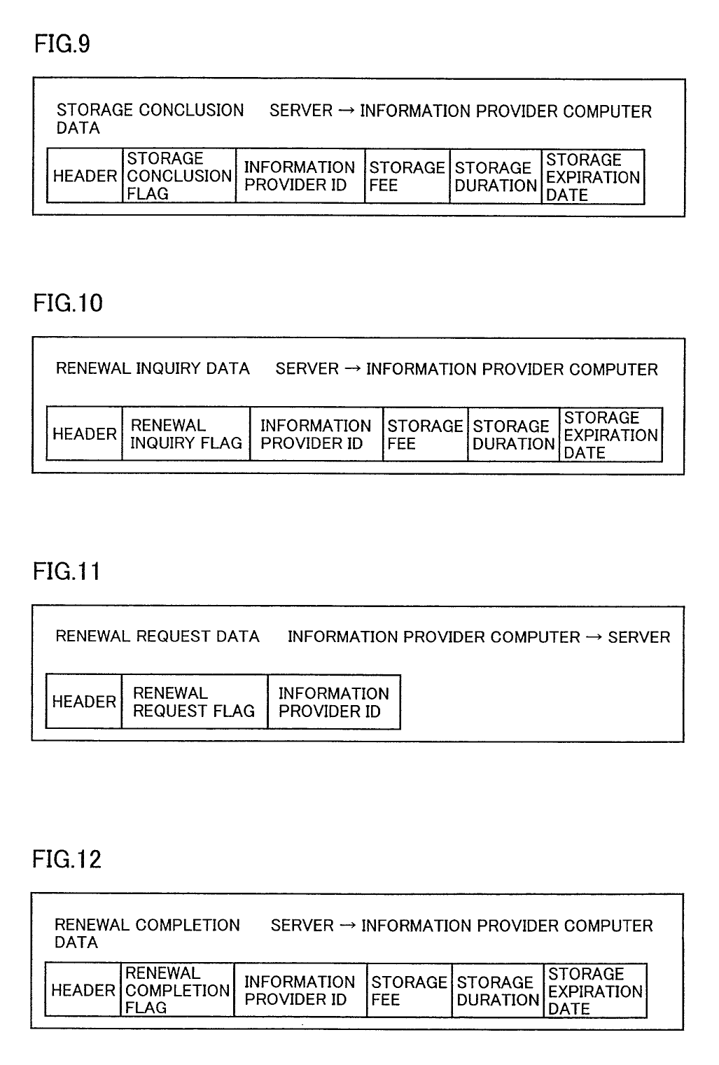

Storage conclusion data transmitted from server 100 to information provider computer 200 will be described with reference to FIG. 9. The storage conclusion data includes a header, a storage conclusion flag, an information provider ID, storage fee, storage duration, and storage expiration date.

Renewal inquiry data transmitted from server 100 to information provider computer 200 will be described with reference to FIG. 10. The renewal inquiry data includes a header, a renewal inquiry flag, an information provider ID, storage fee, storage duration, and storage expiration date. This renewal inquiry data corresponds to inquiry of whether to renew storage of technical data that has reached the storage expiration date.

Renewal request data transmitted from information provider computer 200 to server 100 will be described with reference to FIG. 11. The renewal request data includes a header, a renewal request flag, and an information provider ID. This renewal request data is transmitted to server 100 when the information provider receiving the renewal inquiry data (FIG. 10) requests renewal of the storage of the technical data.

Renewal completion data transmitted from server 100 to information provider computer 200 will be described with reference to FIG. 12. The renewal completion data includes a header, a renewal completion flag, an information provider ID, storage fee, storage duration, and storage expiration date. The storage expiration date (the updated expiration date) of FIG. 12 is the date corresponding to the storage duration added to the storage expiration date shown in FIG. 10.

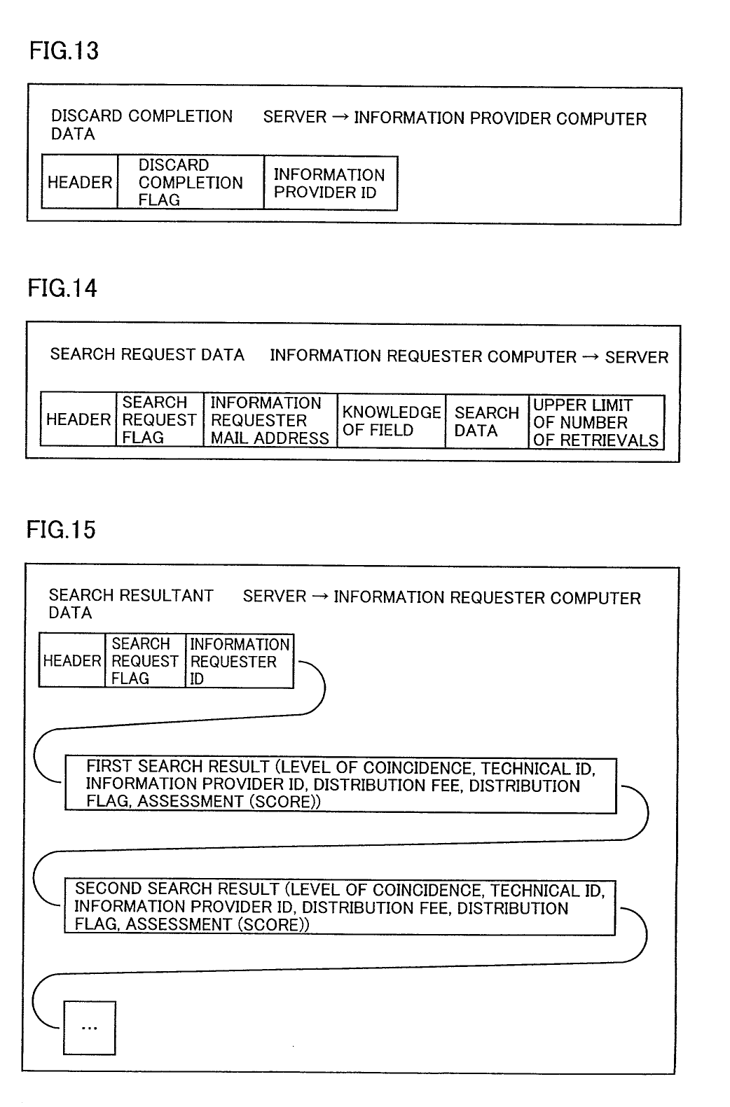

Discard completion data transmitted from server 100 to information provider computer 200 will be described with reference to FIG. 13. The discard completion data includes a header, a discard completion flag and an information provider ID. This discard completion data is transmitted to information provider computer 200 in the case where the information provider receiving the renewal inquiry data (FIG. 10) does not request renewal of storage (that is, renewal request data (FIG. 11) is not transmitted to server 100). This discard completion data is transmitted after the technical data has been deleted from server 100.

Search request data transmitted from information requester computer 300 to server 100 will be described with reference to FIG. 14. The search request data includes a header, a search request flag, the mail address of the information requester, the field of knowledge, search data, and the upper limit of the number of retrievals. This upper limit defines the maximum number of cases of retrieval that is to be transmitted as the search result.

Search resultant data transmitted from server 100 to information requester computer 300 will be described with reference to FIG. 15. The search resultant data includes a header, a search resultant flag, an information requester ID, the first search result (level of coincidence, technical information ID, information provider ID, distribution fee, distribution flag, assessment (score)), and the second search result (level of coincidence, technical information ID, information provider ID, distribution fee, distribution flag, assessment (score)). The level of coincidence is based on the added value of the weights of the compound terms included in the search data. A plurality of retrievals corresponding to the upper limit of the number of retrievals defined in search request data (FIG. 14) is transmitted, starting from that with the highest level of coincidence.

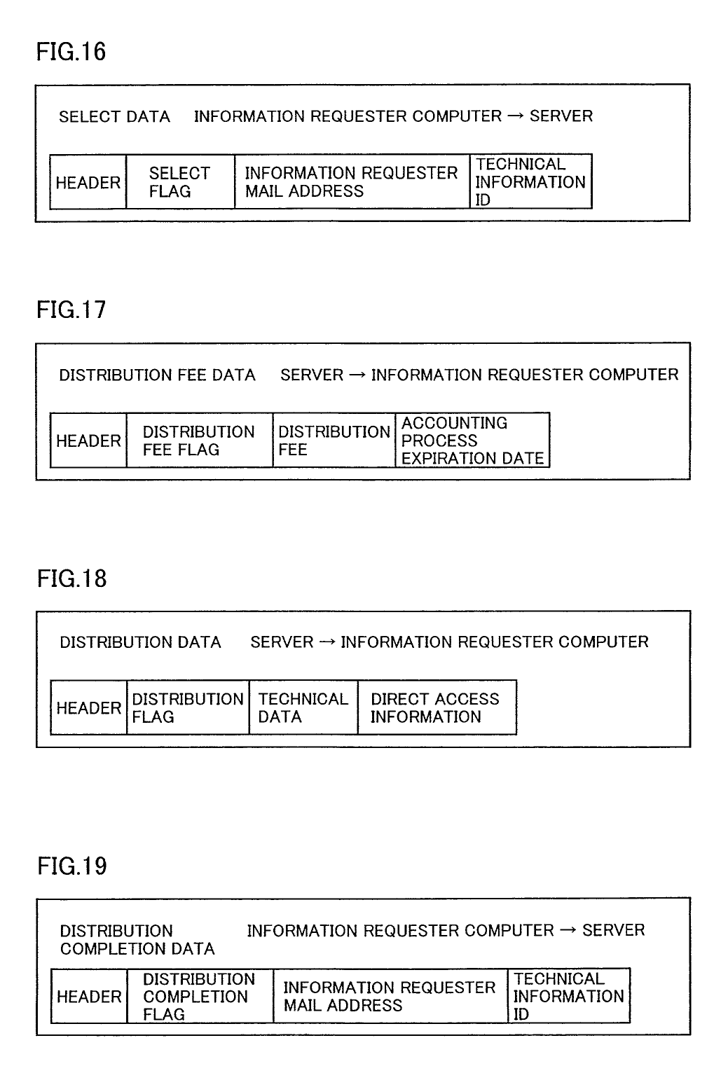

Select data transmitted from information requester computer 300 to server 100 will be described with reference to FIG. 16. The select data includes a header, a select flag, an information requester mail address, and a technical information ID. This select data is transmitted to server 100 after identification of the technical data that is the subject of distribution requested by the information requester receiving the search resultant data (FIG. 15) from server 100.

Distribution fee data transmitted from server 100 to information requester computer 300 will be described with reference to FIG. 17. The distribution fee data includes a header, a distribution fee flag, a distribution fee, and an accounting process expiration date. This accounting process expiration date indicates the due date of executing the accounting process after the distribution fee data is transmitted from server 100. The accounting process is effected using an accounting process server 400.

Distribution data transmitted from server 100 to information requester computer 300 will be described with reference to FIG. 18. The distribution data includes a header, a distribution flag, technical data, and direct access information. This distribution data is transmitted to information requester computer 300 when the information requester who has received the distribution fee data (FIG. 17) transmits the distribution fee to accounting process server 400 before a predetermined accounting process expiration date.

Distribution completion data transmitted from information requester computer 300 to server 100 will be described with reference to FIG. 19. The distribution completion data includes a header, a distribution completion flag, the mail address of the information requester, and a technical information ID. This distribution completion data is transmitted to server 100 from information requester computer 300 who has received the distribution data (FIG. 18) from server 100.

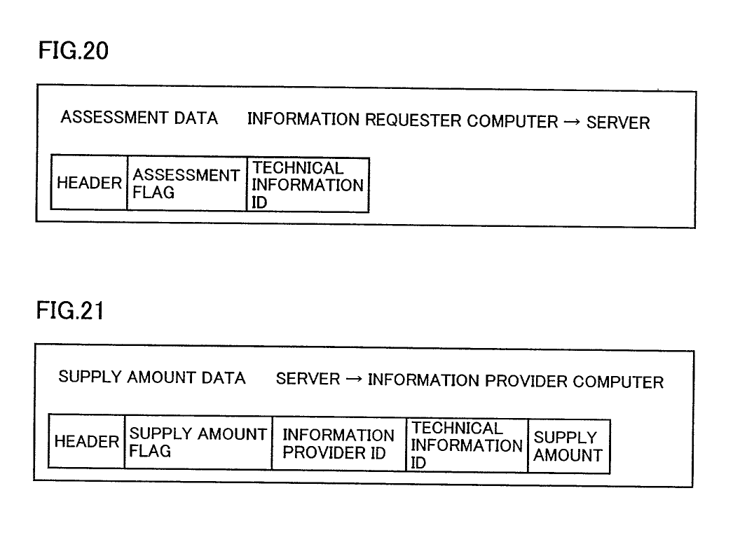

Assessment data transmitted from information requester computer 300 to server 100 will be described with reference to FIG. 20. The assessment data includes a header, an assessment flag and a technical information ID. This assessment data is transmitted to server 100 when determination is made that the technical data is significant by the information requester who has received the distribution data (FIG. 18).

Supply fee data transmitted from server 100 to information provider computer 200 will be described with reference to FIG. 21. The supply fee data includes a header, a supply fee flag, an information provider ID, a technical information ID, and a supply fee. The supply fee is calculated based on the distribution fee paid by the information requester, and is paid as the value of supplying information by the information provider.

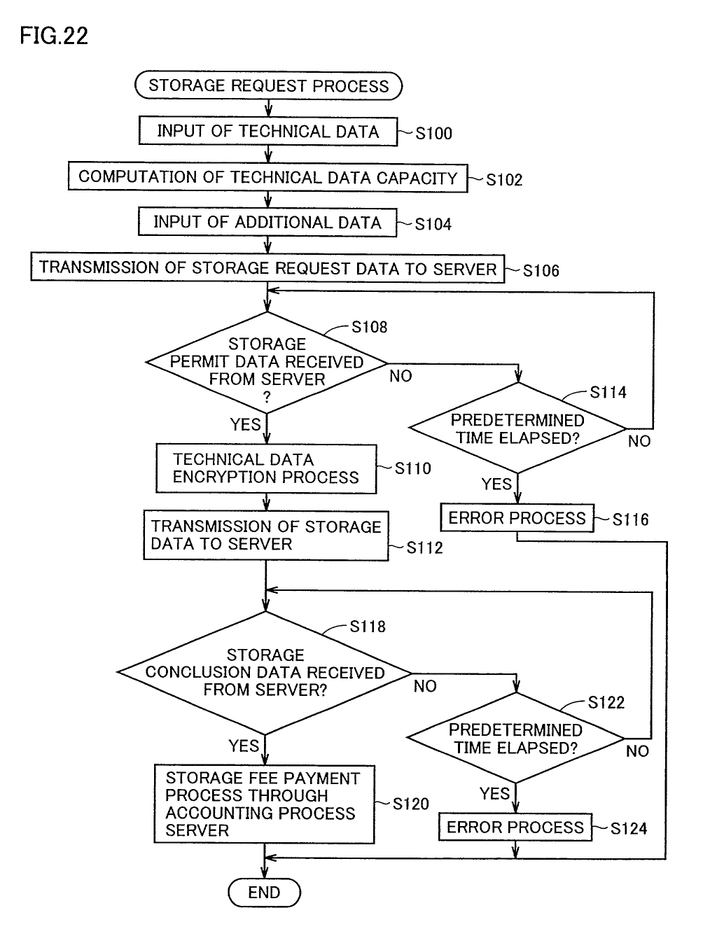

The program of FIG. 22 executed by information provider computer 200 of the technical information intermediary system of the present embodiment has a control structure set forth below as to the storage request process. In the following description, information provider computer 200 and information requester computer 300 respectively have a hardware structure similar to that of server 100 described with reference to FIGS. 2 and 3. Various processes by information provider computer 200 and information requester computer 300 are executed by respective CPUs of information provider computer 200 and information requester computer 300.

At step (step abbreviated as S hereinafter) 100, information provider computer 200 senses input of technical data. This technical data is input by an information provider. At step S102, information provider computer 200 computes the capacity of the technical data input at S100. At S104, information provider computer 200 senses input of additional data. The additional data includes the mail address of the information provider, the field of knowledge, a distribution fee, a distribution flag, a header, direct access information, and the storage duration.

At S106, information provider computer 200 transmits storage request data (FIG. 6) to server 100. At S108, information provider computer 200 determines whether storage permit data (FIG. 7) has been received from server 100. Upon receiving storage permit data from server 100 (YES at S108), control proceeds to S110, otherwise (NO at S108), control proceeds to S114.

At S110, information provider computer 200 applies an encryption process on the technical data input at S100. At S112, information provider computer 200 transmits storage data (FIG. 8) to server 100.

At S114, information provider computer 200 determines whether a predetermined time has elapsed from the transmission (S106) of storage request data (FIG. 6) to server 100 when storage permit data (FIG. 7) is not received from server 100 (NO at S108). When a predetermined time has elapsed (YES at S114), control proceeds to S116, otherwise (NO at S114), control returns to S108 to wait for reception of storage permit data from server 100.

At S116, information provider computer 200 performs an error process. In the case where the capacity of the technical data is so great that it cannot be stored in a predetermined region in hard disk 124 of server 100, server 100 will not transmit storage permit data (FIG. 7) to information provider computer 200. The error process of S116 is performed in such a case.

At S118, information provider computer 200 determines whether storage conclusion data (FIG. 9) has been received from server 100. When storage conclusion data has been received from server 100 (YES at S118), control proceeds to S120, otherwise (NO at S118), control proceeds to S122.

At S120, information provider computer 200 performs the payment process of the storage fee using accounting process server 400. At S122, information provider computer 200 determines whether a predetermined time has elapsed from the transmission (S112) of storage data (FIG. 8) to server 100. When a predetermined time has elapsed (YES at S122), control proceeds to S124, otherwise (NO at S122), control proceeds to S118 to wait for reception of storage conclusion data from server 100.

At S124, information provider computer 200 performs an error process. The error process of S124 is effected when the storage data (FIG. 8) transmitted to the technical database (FIG. 4) of server 100 at S112 could not be stored.

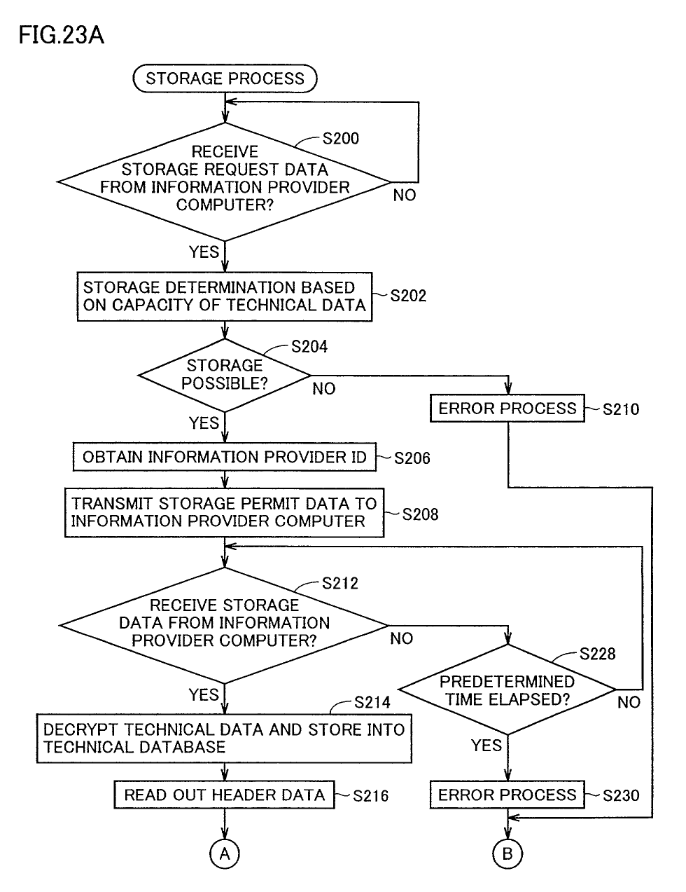

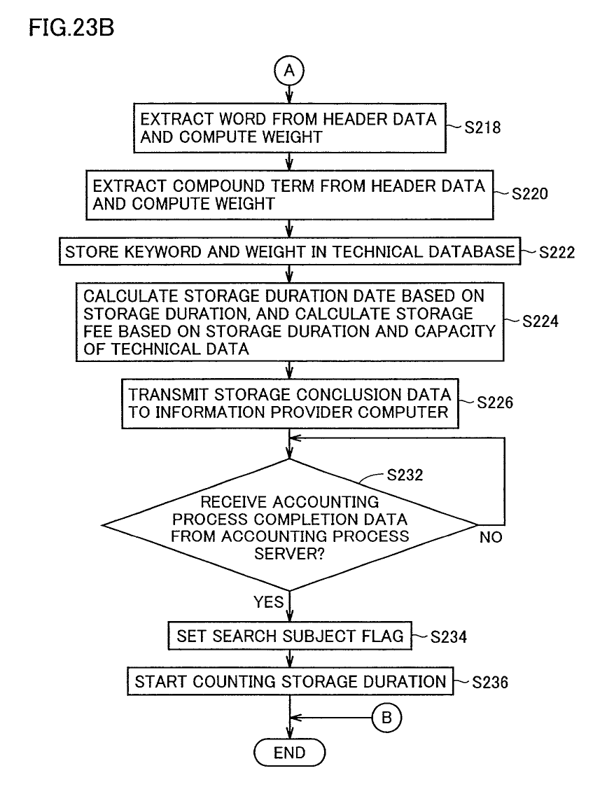

The program of FIGS. 23A and 23B executed at server 100 has a control structure set forth below as to the storage process.

At S200, CPU 120 of server 100 determines whether storage request data (FIG. 6) has been received from information provider computer 200. Upon reception of storage request data from information provider computer 200 (YES at S200), control proceeds to S202, otherwise (NO at S200), control returns to S200 to wait for reception of storage request data from information provider computer 200.

At S202, CPU 120 performs storage determination based on the capacity of the technical data included in the storage request data received at S200. At S204, CPU 120 determines whether storage is possible or not. When storage is possible (YES at S204), control proceeds to S206, otherwise (NO at S204), control proceeds to S210.

At S206, CPU 120 obtains the information provider ID. At S208, CPU 120 transmits storage permit data (FIG. 7) to information provider computer 200.

At S210, CPU 120 performs an error process. In the error process of S210, display is provided on monitor 104 indicating that storage of technical data is not possible.

At S212, CPU 120 determines whether storage data (FIG. 8) has been received from information provider computer 200. When storage data is received from information provider computer 200 (YES at S212), control proceeds to S214, otherwise (NO at S212), control proceeds to S228.

At S214, CPU 120 decrypts the technical data included in the storage data received at S212 and stores the decrypted technical data in the technical database (FIG. 4).

At S216, CPU 120 reads out the header data included in the storage data. At S218, CPU 120 retrieves words from the header data read out at S216 to compute the weights of the words. At S220, CPU 120 retrieves compound terms from the header data to compute the weight. The weighting method of words and compound terms is as described previously with reference to FIGS. 5A-5C. Therefore, description thereof is not repeated here.

At S222, CPU 120 stores the words retrieved at S218 and the compound terms retrieved at S220 as keywords, as well as weights corresponding to respective keywords in the technical database (FIG. 4).

At S224, CPU 120 calculates the storage expiration date based on the storage duration and also the storage fee based on the storage duration and capacity of the technical data. The storage fee becomes higher as the storage duration becomes longer and the capacity of the stored technical data is larger. At S226, CPU 120 transmits storage conclusion data (FIG. 9) to information provider computer 200.

At S228, CPU 120 determines whether a predetermined time has elapsed from transmission (S208) of storage permit data (FIG. 7) to information provider computer 200. When a predetermined time has elapsed (YES at S228), control proceeds to S230, otherwise (NO at S228), control returns to S212 to wait for reception of storage data from information provider computer 200.

At S230, CPU 120 performs an error process. In this error process of S230, display is provided on monitor 104 indicating that storage data has not been transmitted from information provider computer 200 even though server 100 has transmitted storage permit data to information provider computer 200.

At S232, CPU 120 determines whether accounting process completion data has been received from accounting process server 400. When accounting process completion data is received from accounting process server 400 (YES at S232), control proceeds to S234, otherwise (NO at S232), control returns to S232 to wait for reception of accounting process completion data from accounting process server 400.

At S234, CPU 120 sets the search subject flag (reset at initial state) of the technical database (FIG. 4). Accordingly, this technical data becomes the subject of search by server 100. At S236, CPU 120 initiates the counting of the storage duration.

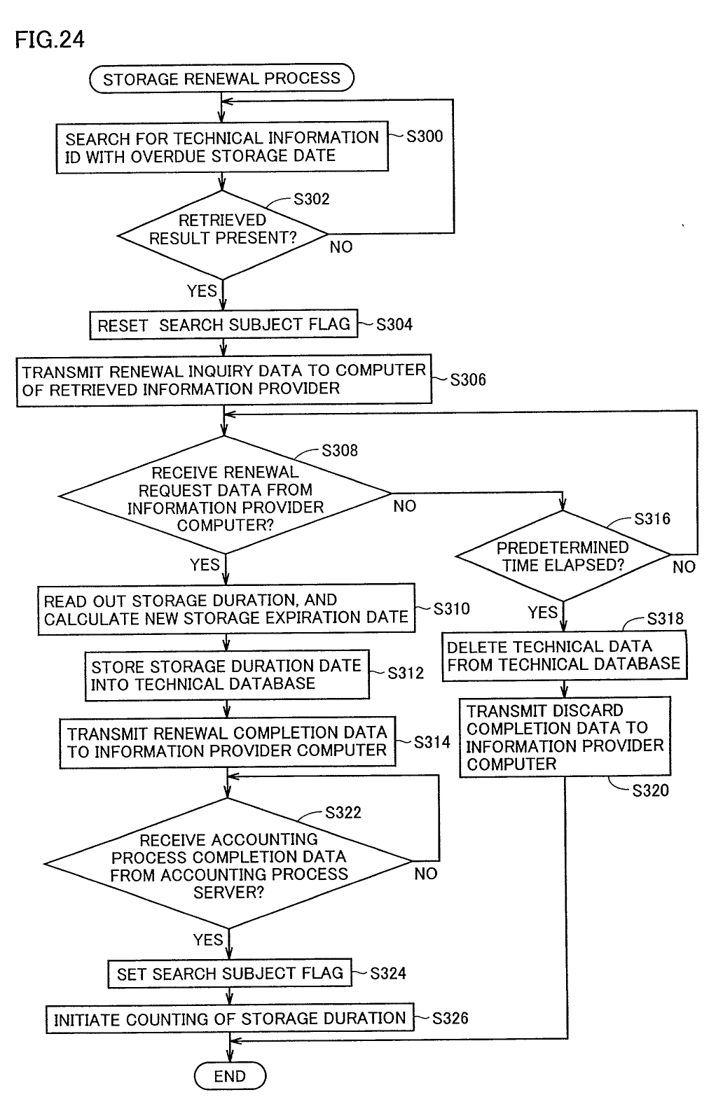

The program of FIG. 24 executed by server 100 has a control structure set forth below as to the storage renewal process.

At S300, CPU 120 retrieves the technical information ID having a storage expiration date that is overdue from the technical database (FIG. 4). At S302, CPU 120 determines whether there is a relevant technical information ID as the result of the search. When there is a retrieved result (YES at S302), control proceeds to S304, otherwise (NO at S302), control returns to S300 to search again for a technical information ID with an overdue storage expiration date.

At S304, CPU 120 resets the search subject flag of the retrieved technical information ID. At S306, CPU 120 transmits renewal inquiry data (FIG. 10) to computer 200 of the information provider who has been identified as a result of the search.

At S308, CPU 120 determines whether renewal request data (FIG. 11) has been received from information provider computer 200. When renewal request data is received from information provider computer 200 (YES at S308), control proceeds to S310, otherwise (NO at S308), control proceeds to S316.

At S310, CPU 120 reads out the storage duration of the technical database (FIG. 4) and calculates the new storage expiration date and storage fee. At S312, CPU 120 stores the storage expiration date into the technical database (FIG. 4). At S314, CPU 120 transmits renewal completion data (FIG. 12) to information provider computer 200.

At S316, CPU 120 determines whether a predetermined time has elapsed from transmission (S306) of the renewal inquiry data (FIG. 10) to information provider computer 200. When a predetermined time has elapsed (YES at S316), control proceeds to S318, otherwise (NO at S316), control returns to S308 to wait for reception of renewal request data from information provider computer 200.

At S318, CPU 120 deletes the technical data from the technical database (FIG. 4). At S320, CPU 120 transmits discard completion data (FIG. 13) to information provider computer 200.

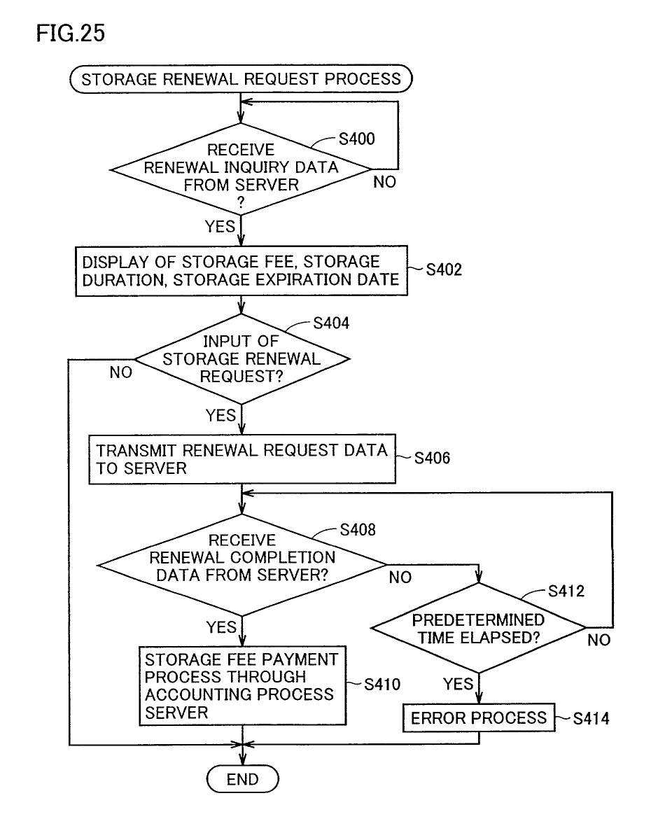

The program of FIG. 25 executed by information provider computer 200 has a control structure set forth below as to the storage renewal request process.

At S400, information provider computer 200 determines whether renewal inquiry data (FIG. 10) has been received from server 100. When renewal inquiry data has been received from server 100 (YES at S400), control proceeds to S402, otherwise (NO at S400), control returns to S400 to wait for reception of renewal inquiry data from server 100.

At S402, information provider computer 200 provides the display of the storage fee, storage duration and storage expiration date on the monitor. The information provider is notified of the storage fee, storage duration and storage expiration date through this display.

At S404, information provider computer 200 determines whether input of storage renewal request has been sensed. Upon sensing input of a storage renewal request (YES at S404), control proceeds to S406, and otherwise (NO at S404), this storage renewal request process is terminated. At S406, information provider computer 200 transmits renewal request data (FIG. 11) to server 100.

At S408, information provider computer 200 determines whether renewal completion data (FIG. 12) has been received from server 100. When renewal completion data is received from server 100 (YES at S408), control proceeds to S410, and otherwise (NO at S408), control proceeds to S412.

At S410, information provider computer 200 carries out the payment process of the storage fee using accounting process server 400. At S412, information provider computer 200 determines whether a predetermined time has elapsed from transmission (S406) of renewal request data (FIG. 11) to server 100. When a predetermined time has elapsed (YES at S412), control proceeds to S414, otherwise (NO at S412), control proceeds to S408 to wait for reception of renewal completion data from server 100.

At S414, information provider computer 200 carries out an error process. In this error process of S414, display is provided on the monitor indicating that renewal completion data cannot be received from server 100 due to trouble in the communication line between server 100 and information provider computer 200.

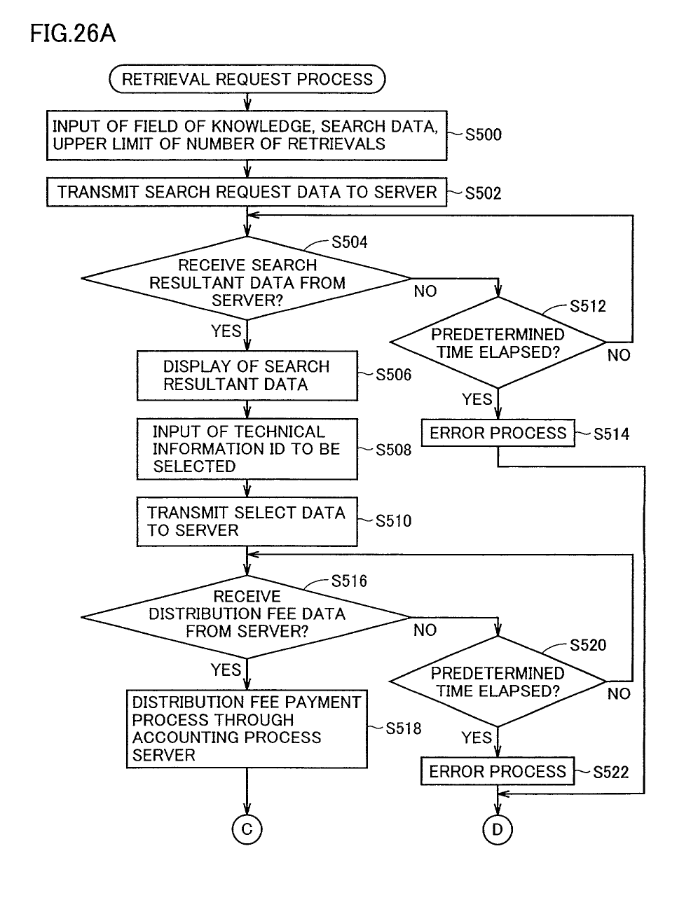

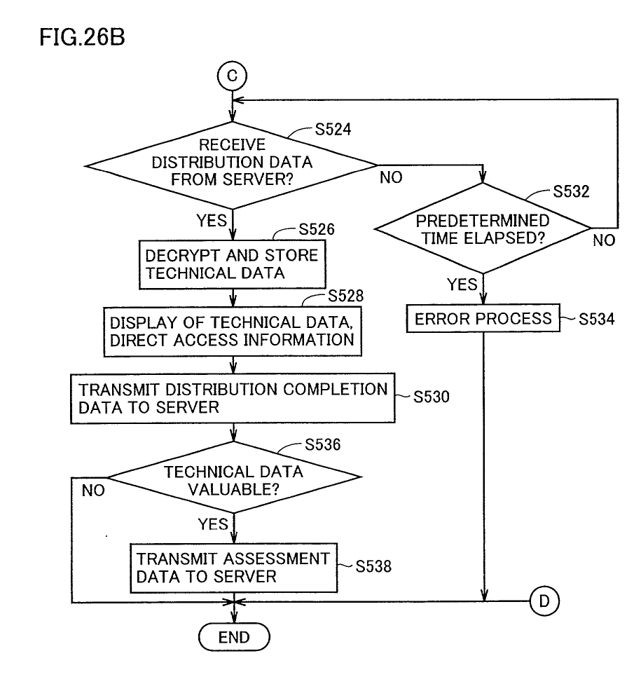

The program of FIGS. 26A and 26B executed by information requester computer 300 has a control structure set forth below as to a search request process.

Information requester computer 300 senses input of the field of knowledge, search data, and the upper limit of the number of retrievals. At S502, information requester computer 300 transmits search request data (FIG. 14) to server 100.

At S504, information requester computer 300 determines whether search resultant data (FIG. 15) has been received from server 100. When search resultant data is received from server 100 (YES at S504), control proceeds to S506, otherwise (NO at S504), control proceeds to S512.

At S506, information requester computer 300 provides display on the monitor indicating the search resultant data received at S504. Accordingly, the information requester is notified of the search result.

At S508, information requester computer 300 senses input of a technical information ID. At S510, information requester computer 300 transmits to server 100 select data generated (FIG. 16) based on the technical information ID input at S508.

At S512, information requester computer 300 determines whether a predetermined time has elapsed from transmission (S502) of search request data (FIG. 14) to server 100. When a predetermined time has elapsed (YES at S512), control proceeds to S514, and otherwise (NO at S512), control returns to S504 to wait for reception of search resultant data from server 100.

At S514, information requester computer 300 carries out an error process. In this error process of S514, display is provided on the monitor indicating that the search result is not transmitted from server 100 even though search request data has been transmitted to server 100.

At S516, information requester computer 300 determines whether distribution fee data (FIG. 17) is received from server 100. When distribution fee data is received from server 100 (YES at S516), control proceeds to S518, and otherwise (NO at S516), control proceeds to S520.

At S518, information requester computer 300 carries out the payment process of the distribution fee through accounting process server 400. At S520, information requester computer 300 determines whether a predetermined time has elapsed from transmission (S510) of select data (FIG. 16) to server 100. When a predetermined time has elapsed (YES at S520), control proceeds to S520, and otherwise (NO at S520), control returns to S516 to wait for reception of distribution fee data from server 100.

At S522, information requester computer 300 carries out an error process. In this error process of S522, display is provided on the monitor indicating that distribution fee data is not received from server 100 even though select data has been transmitted to server 100.

At S524, information requester computer 300 determines whether distribution data (FIG. 18) is received from server 100. When distribution data is received from server 100 (YES at S524), control proceeds to S526, and otherwise (NO at S524), control proceeds to S532.

At S526, information requester computer 300 decrypts and stores the technical data. At S528, information requester computer 300 displays the decrypted technical data and direct access information based on the distribution flag. At S530, information requester computer 300 transmits distribution completion data (FIG. 19) to server 100.

At S532, information requester computer 300 determines whether a predetermined time has elapsed from the payment process of the distribution fee. When a predetermined time has elapsed (YES at S532), control proceeds to S534, otherwise (NO at S532), control returns to S524 to wait for reception of distribution data from server 100.

At S534, information requester computer 300 carries out an error process. In this error process of S534, display is provided on the monitor indicating that distribution data is not received from server 100 even though the payment process of the distribution fee has been carried out.

At S536, information requester computer 300 determines whether input indicating that the technical data is valuable is sensed. When input indicating that the technical data is valuable is sensed (YES at S536), control proceeds to S538, and otherwise (NO at S536), this search request process ends. At S538, information requester computer 300 transmits assessment data (FIG. 20) to server 100.

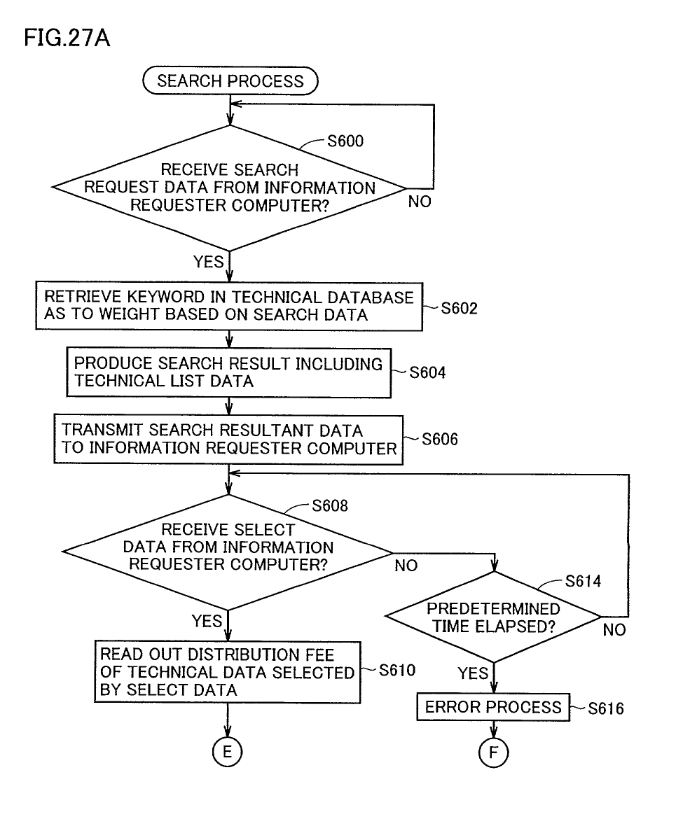

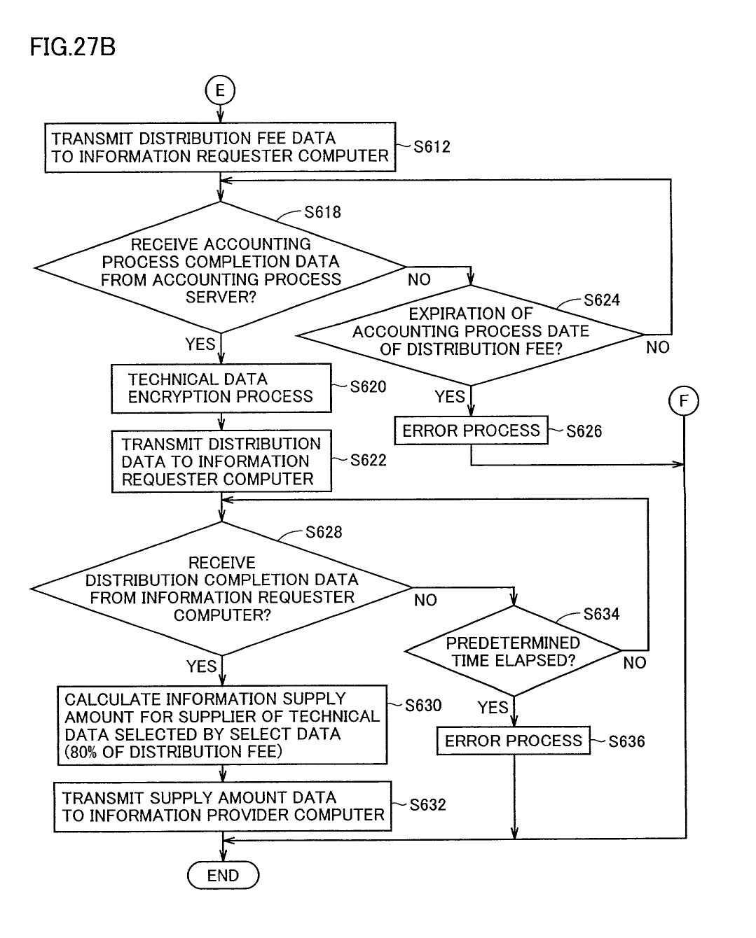

The program of FIGS. 27A and 27B executed by server 100 has a control structure set forth below as to the search process.

At S600, CPU 120 determines whether search request data (FIG. 14) is received from information requester computer 300. When search request data is received from information requester computer 300 (YES at S600), control proceeds to S602, and otherwise (NO at S600), control returns to S600 to wait for reception of retrieval request data from information requester computer 300.

At S602, CPU 120 retrieves the weights of the keywords in the technical database (FIG. 4) based on the search data included in the received search request data (FIG. 14). At S604, CPU 120 generates a search result including a list of the retrieved technical information. The search result includes the level of coincidence based on a calculated value obtained by adding weights. At S606, CPU 120 transmits the search resultant data (FIG. 15) including the search result generated at S604 to information requester computer 300.

At S608, CPU 120 determines whether select data (FIG. 16) is received from information requester computer 300. When select data is received from information requester computer 300 (YES at S608), control proceeds to S610, and otherwise (NO at S608), control proceeds to S614.

At S610, CPU 120 reads out the distribution fee of the technical data selected through the select data received at S608. At S612, CPU 120 transmits to information requester computer 300 the distribution fee data (FIG. 17) including the distribution fee read out at S610.

At S614, CPU 120 determines whether a predetermined time has elapsed from transmission (S606) of the search resultant data (FIG. 15) to information requester computer 300. When a predetermined time has elapsed (YES at S614), control proceeds to S616, otherwise (NO at S614), control returns to S608 to wait for reception of select data from information requester computer 300.

At S616, CPU 120 carries out an error process. In the error process of S616, display is provided on the monitor indicating that select data is not received from information requester computer 300 even though search resultant data has been transmitted.

At S618, CPU 120 determines whether accounting process completion data is received from accounting process server 400. When accounting process completion data is received from accounting process server 400 (YES at S618), control proceeds to S620, and otherwise (NO at S618), control proceeds to S624.

At S620, CPU 120 applies an encryption process on the technical data. At S622, CPU 120 transmits distribution data (FIG. 18) to information requester computer 300.

At S624, CPU 120 determines whether the accounting process expiration date of the distribution fee is overdue. When the accounting process expiration date of transmission fee has passed (YES at S624), control proceeds to S626, and otherwise (NO at S624), control returns to S618 to wait for reception of accounting process completion data from accounting process server 400.

At S626, CPU 120 carries out an error process. In this error process of S626, display is provided on the monitor indicating that the information requester did not carry out the accounting process by the predetermined accounting process expiration date even though distribution fee data has been transmitted.

At S628, CPU 120 determines whether distribution completion data (FIG. 19) is received from information requester computer 300. When distribution completion data is received from information requester computer 300 (YES at S628), control proceeds to S630, and otherwise (NO at S628), control proceeds to S634.

At S630, CPU 120 calculates the information supply amount for the information provider who has provided the technical data selected by an information requester. For example, this information supply amount is calculated as 80% of the distribution fee. Twenty percent of the distribution fee is collected by an administrator of server 100. At S632, CPU 120 transmits supply amount data (FIG. 21) to information requester computer 300.

At S634, CPU 120 determines whether a predetermined time has elapsed from transmission (S622) of distribution data (FIG. 18) to information requester computer 300. When a predetermined time has elapsed (YES at S634), control proceeds to S636, and otherwise (NO at S634), control returns to S628 to wait for reception of distribution completion data from information requester computer 300.

At S636, CPU 120 carries out an error process. In this error process of S636, display is provided on the monitor indicating that distribution completion data is not received from information requester computer 300 even though distribution data has been transmitted to information requester computer 300.

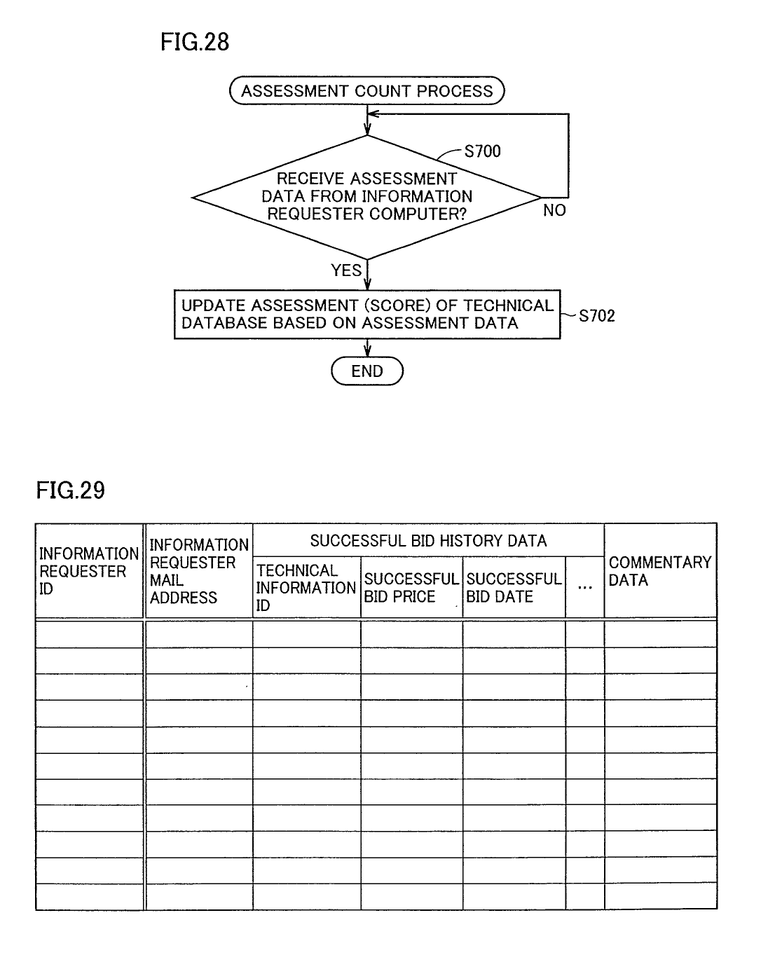

The program of FIG. 28 executed by server 100 of the present embodiment has a control structure set forth below as to the assessment count process.

At S700, CPU 120 determines whether assessment data (FIG. 20) is received from information requester computer 300. When assessment data is received from information requester computer 300 (YES at S700), control proceeds to S702, and otherwise (NO at S700), control returns to S700 to wait for reception of assessment data from information requester computer 300. At S702, CPU 120 updates the assessment (score) of the technical database (FIG. 4) based on the assessment data received at S700.

The operation of the technical information intermediary system according to the above structure and flow charts will be described hereinafter.

[Information Provider Computer: Storage Request Operation]

Upon input of his/her own skill or technique as technical data by an information provider (S100), the capacity of the input technical data is calculated (S102). Additional data is input by the information provider (S104). Storage request data (FIG. 6) is transmitted to server 100 (S106). When storage permit data (FIG. 7) is received from server 100 (YES at S108), information provider computer 200 encrypts the technical data (S110). Storage data (FIG. 8) including the encrypted technical data is transmitted to server 100 (S112). When storage conclusion data (FIG. 9) is received from server 100 (YES at S118), information provider computer 200 carries out the storage fee payment process through accounting process server 400.

[Server: Storage Operation]

When storage request data (FIG. 6) is received from information provider computer 200 (YES at S200), determination is made whether storage is possible or not based on the capacity of the technical data included in the storage request data (S202). When determination is made that storage is possible (YES at S204), the information provider ID is obtained (S206). Storage permit data (FIG. 7) is transmitted to information provider computer 200 (S208).

When server 100 receives storage data (FIG. 8) from information provider computer 200 (YES at S212), technical data is decrypted and stored in the technical database (FIG. 4) (S214). The header data is read out (S216). Words are retrieved from the read out header data, and the weight is computed (S218). Compound terms are retrieved from the read out data and weight is computed (S220). Using the words and compound terms as keywords, weights corresponding to respective keywords are stored in technical database (FIG. 4) (S222). The storage expiration date is calculated based on the storage duration, and the storage fee is calculated based on the storage duration and capacity of the technical data (S224). Storage completion data (FIG. 9) is transmitted to information provider computer 200 (S226).

When accounting process completion data for the storage fee is received from accounting process server 400 (YES at S232), the search subject flag of the technical database (FIG. 4) is set (S234). Counting of the storage duration is initiated (S236).

[Server: Storage Renewal Operation]

Any technical information ID with an expired date of storage is retrieved (S300) from the technical database (FIG. 4) for every predetermined period of time. When there is a technical information ID with an expired date of storage as a result of the search (YES at S300), the search subject flag of the retrieved technical information ID is reset (S304). Renewal inquiry data (FIG. 10) is transmitted to information provider computer 200 of the retrieved technical information ID (S306). When renewal request data (FIG. 11) is received from information provider computer 200 (YES at S308), the storage duration is read out and the new storage duration and storage fee are calculated (S310). The storage expiration date is stored (S312) in the technical database (FIG. 4), and renewal completion data (FIG. 12) is transmitted to information provider computer 200 (S314).

When accounting process completion data with respect to the storage fee corresponding to renewal is received from accounting process server 400 (YES at S322), the search subject flag of the technical data (FIG. 4) is set (S324). Counting of the storage duration is initiated (S326).

[Information Provider Computer: Storage Renewal Request Operation]

When renewal inquiry data (FIG. 10) is received from server 100 (YES at S400), the storage fee, storage duration and storage expiration date are displayed on the monitor of information provider computer 200 (S402). If the information provider requests further storage, storage renewal request is input (YES at S404). Renewal request data (FIG. 11) is transmitted to server 100 (S406).

When renewal completion data (FIG. 12) is received from server 100 (YES at S408), information provider computer 200 carries out the payment process of the storage fee corresponding to the renewal through accounting process server 400.

[Information Requester Computer: Search Request Operation]

When an information requester requires search of technical information, the field of knowledge, search data and the upper limit of the number of retrievals are input into information requester computer 300 (S500). Search request data (FIG. 14) including the input field of knowledge, search data and the upper limit of the number of retrievals is transmitted to server 100 (S502).

When search resultant data (FIG. 15) is received from server 100 (YES at S504), search resultant data is displayed on the monitor of information requester computer 300. The information requester selects the required technical data through the header data of the retrieved technical data displayed on the monitor. When the information requester inputs a technical information ID to be selected (S508), select data (FIG. 16) is transmitted to server 100 (S510).

When distribution fee data (FIG. 17) is received from server 100 (YES at S516), information requester computer 300 carries out the distribution fee payment process through accounting process server 400 (S518).

When distribution data (FIG. 18) is received from server 100 (YES at S528), the technical data included in the received distribution data is decrypted and stored (S526). Technical data or direct access information is displayed on the monitor based on the distribution flag (S528). Distribution completion data (FIG. 19) is transmitted to server 100 (S530). Accordingly, an information requester obtains the required technical information.

When the information requester determines that the obtained technical data is valuable (YES at S536), assessment data (FIG. 20) is transmitted to server 100 (S538).

[Server: Search Operation]

When server 100 receives search request data (FIG. 14) from information requester computer 300 (YES at S600), the keyword in the technical database (FIG. 4) is retrieved as to the weight based on the received search data (S602). Here, only the technical information ID with a set search subject flag is taken as the subject of search. The search result including the level of coincidence is produced (S604). Search resultant data (FIG. 15) including the retrieved result is transmitted to information requester computer 300 (S606).

When select data (FIG. 16) is received from information requester computer 300 (YES at S608), the distribution fee of the technical data selected through the select data is read out (S610). Distribution fee data (FIG. 17) is transmitted to information requester computer 300 (S612).

When information requester computer 300 carries out the accounting process through accounting process server 400, server 100 receives accounting process completion data from accounting process server 400 (YES at S618). An encryption process is applied on the technical data (S620). Distribution data (FIG. 18) is transmitted to information requester computer 300 (S622).

When distribution completion data (FIG. 19) is received from information requester computer 300 (YES at S618), the information supply amount to be paid to the technical data provider is calculated (S630). Supply amount data including the calculated supply amount (FIG. 21) is transmitted to information provider computer 200 (S632).

[Server: Assessment Count Operation]

When assessment data (FIG. 20) is received from information requester computer 300 (YES at S700), the assessment (score) of the technical data (FIG. 4) is updated (S702).

The technical information intermediary system of the present embodiment receives technical information from an information provider and stores the received information into the technical database of the server. The words and compound terms included in the header data representing the summary of the technical data are retrieved. A weight greater than that of the words included in the compound term is assigned to the compound term. When search data is transmitted from an information requester, the level of coincidence between the search data and the header data is calculated by adding the weights applied to the compound term. Technical data including header data that matches the search data is transmitted to the information requester. The information requester can generate search data to execute a search without having to take into account the abstract concept of technique. Thus, a technical information intermediary system that can easily and properly retrieve technical information and provide the information to an information requester can be provided.

### Second Embodiment

According to a technical information intermediary system according to a second embodiment of the present invention, the header data of the selected technical data based on the select data from an information requester are transmitted to other information requesters who are registered in advance. Bidding for distribution of the information is effected by the information requesters who have received the header data. Since technical data is distributed on the condition that the auction has concluded, the distribution flag corresponds to authorized distribution. All other elements are identical to those of the previous first embodiment. Therefore, detailed description thereof will not be repeated here.

The information requester database stored in hard disk 124 of server 100 will be described with reference to FIG. 29. The information requester database includes the mail address of the information requester, successful bid history data, and commentary data for each information requester ID that is unique to each information requester. The successful bid history data includes the technical information ID that has been awarded in the past, the successful bid price and successful bid date. Commentary data includes information such as the fact that distribution fee was not paid and technical data not received even though awarded in the auction. The information requester utilizing this technical information intermediary system effects registration into the information requester database (FIG. 29) with respect to server 100.

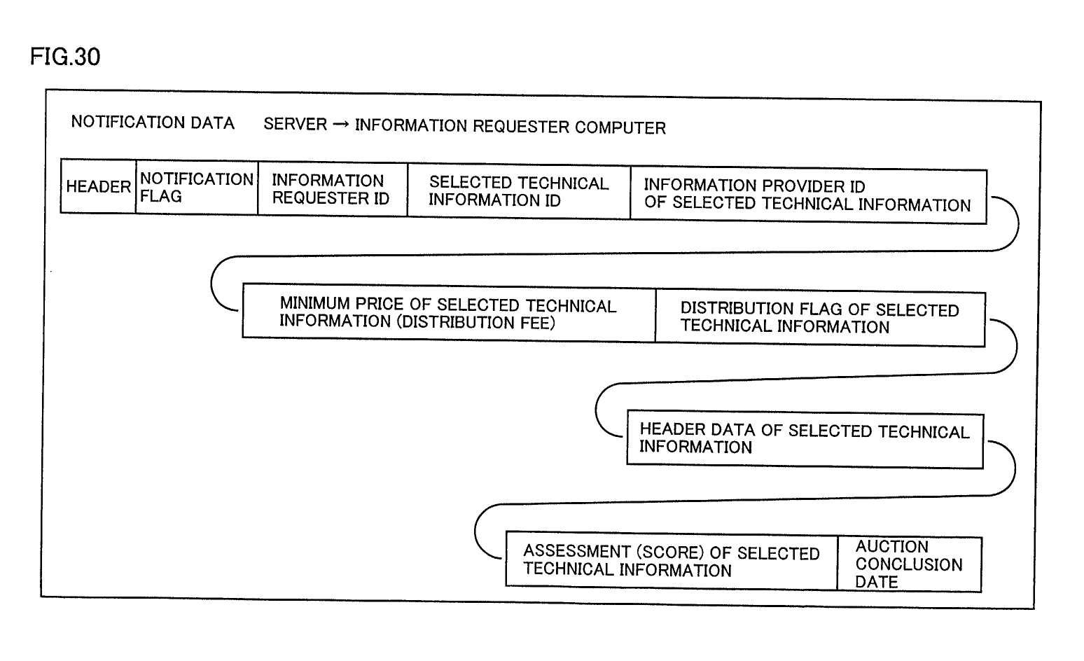

Notification data transmitted from server 100 to information requester computer 300 will be described with reference to FIG. 30. The notification data includes a header, a notification flag, an information requester ID, the selected technical information ID, the information provider ID of the selected technical information, the minimum price of the selected technical information (distribution fee), a distribution flag of the selected technical information, header data of the selected technical information, assessment (score) of the selected technical information, and the auction conclusion date.

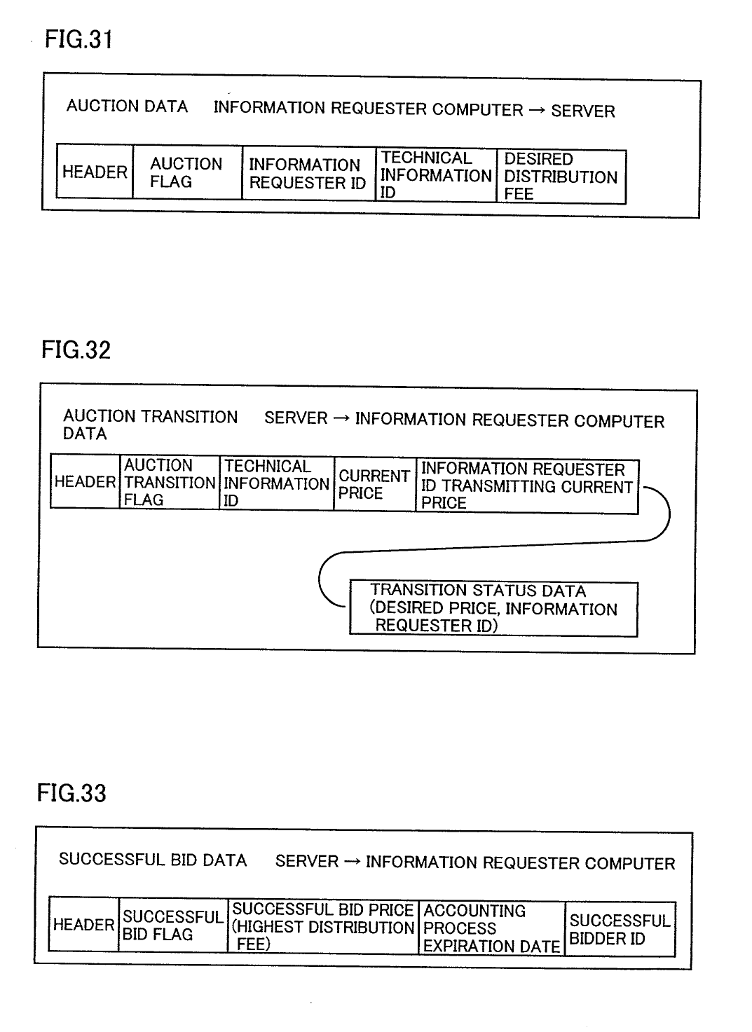

Auction data transmitted from information requester computer 300 to server 100 will be described with reference to FIG. 31. The auction data includes a header, an auction flag, an information requester ID, a technical information ID, and desired distribution fee. This auction data is transmitted to server 100 by the information requester who has received notification data (FIG. 30) when distribution of technical information is requested.

Auction transition data transmitted from server 100 to information requester computer 300 will be described with reference to FIG. 32. The auction transition data includes a header, an auction transition flag, a technical information ID, the current price, the information requester ID who has offered the current price, and the transition status data (desired price, information requester ID). The transition status data is generated based on the transmitted auction data. The transition status data represents the transition of the auction. By this information, an information requester will know about the transition of the change in the desired price in the auction.

Successful bid data transmitted from server 100 to information requester computer 300 will be described with reference to FIG. 33. The successful bid data includes a header, a successful bid flag, the successful bid price (highest distribution fee), the accounting process expiration date, and the successful bidder ID. The successful bidder ID is the identification code to identify the information requester who has offered the highest distribution fee at the conclusion of the auction. This successful bidder ID is transmitted from server 100 to accounting process server 400. In accounting process server 400, the information requester who has executed the success bid price accounting process can be identified.

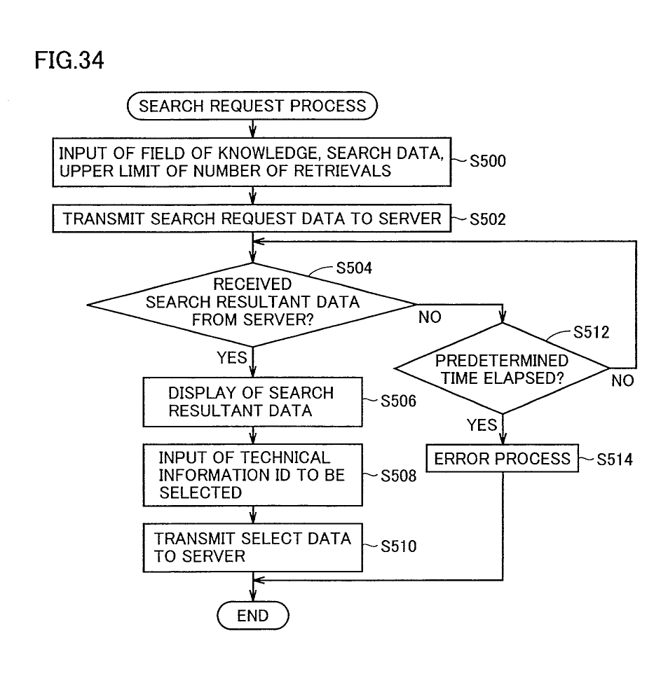

The program of FIG. 34 executed by information requester computer 300 has a control structure set forth below as to a search request process. In the process of FIG. 34, steps identical to those of FIG. 26 in the first embodiment have the same step numbers allotted. Therefore, detailed description thereof will not be repeated here.

At S500, information requester computer 300 detects the input of the field of knowledge, search data, and the upper limit of the number of retrievals from an information requester. The process from S502 to S510 is identical to the process of FIG. 26 in the first embodiment, except for the search request process being concluded when the process of S510 ends.

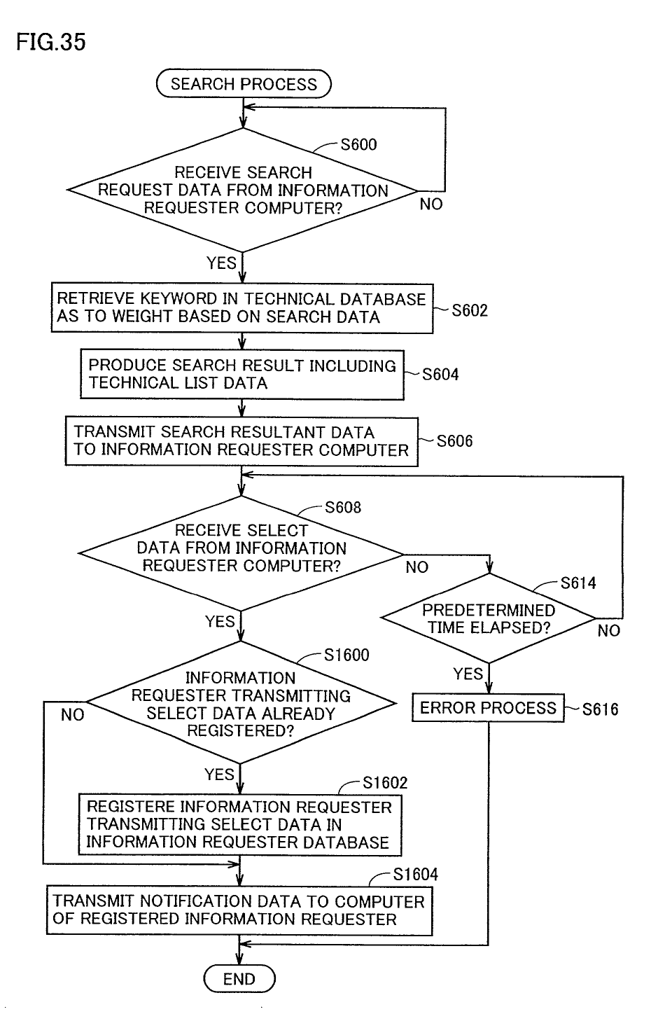

The program of FIG. 35 executed by server 100 has a control structure set forth below as to a search process. In the process of FIG. 35, steps identical to those of FIG. 27 in the previous first embodiment have the same step numbers allotted. Detailed description thereof will not be repeated here.

When CPU 120 receives select data (FIG. 16) from information requester computer 300 (YES at S608), control proceeds to S1600. At S1600, CPU 120 determines whether the information requester who has transmitted the select data received at S608 is already registered in the information requester database (FIG. 29). When that information requester is already registered (YES at S1600), control proceeds to S1604, otherwise (NO at S1600), control proceeds to S1602. At S1602, CPU 120 registers that information requester in the information requester database (FIG. 29).

At S1604, CPU 120 transmits notification data (FIG. 30) to information requester computer 300 of the requester who is registered in the information requester database (FIG. 29). Here, notification data is also transmitted to computer 300 of the information requester who has transmitted the select data.

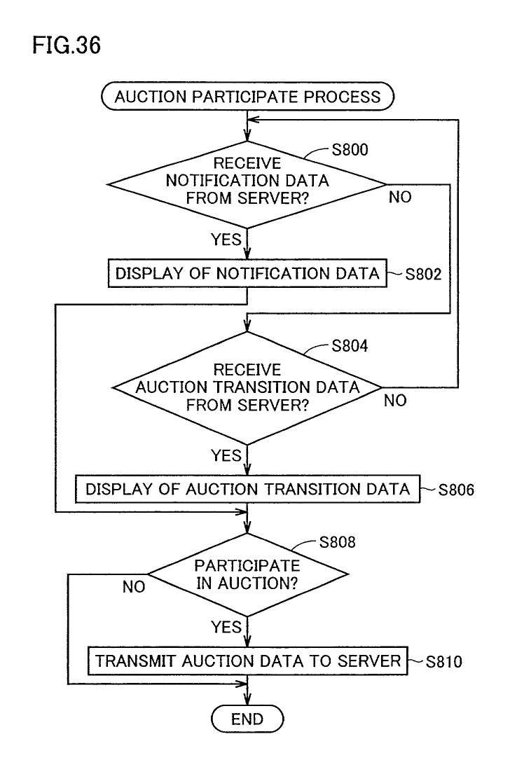

The program of FIG. 36 executed by information requester computer 300 has a control structure set forth below as to an auction participating process.

At S800, information requester computer 300 determines whether notification data (FIG. 30) is received from server 100. When notification data is received from server 100 (YES at S800), control proceeds to S802, and otherwise (NO at S800), control proceeds to S804.

At S802, information requester computer 300 displays the received notification data on the monitor. Then, control proceeds to S808.

At S804, information requester computer 300 determines whether auction transition data (FIG. 32) is received from server 100. When auction transition data is received from server 100 (YES at S804), control proceeds to S806, and otherwise (NO at S804), control returns to S800 where determination is made whether notification data or auction transition data is received from server 100. At S806, information requester computer 300 displays the auction transition data received at S804 on the monitor.

At S808, information requester computer 300 determines whether input of participating the auction is sensed. This determination is based on an information requester entering a desired distribution fee to information requester computer 300. When input of participating the auction is sensed (YES at S808), control proceeds to S810, otherwise (NO at S808), this auction participate process ends. At S810, information requester computer 300 transmits auction data (FIG. 31) to server 100.

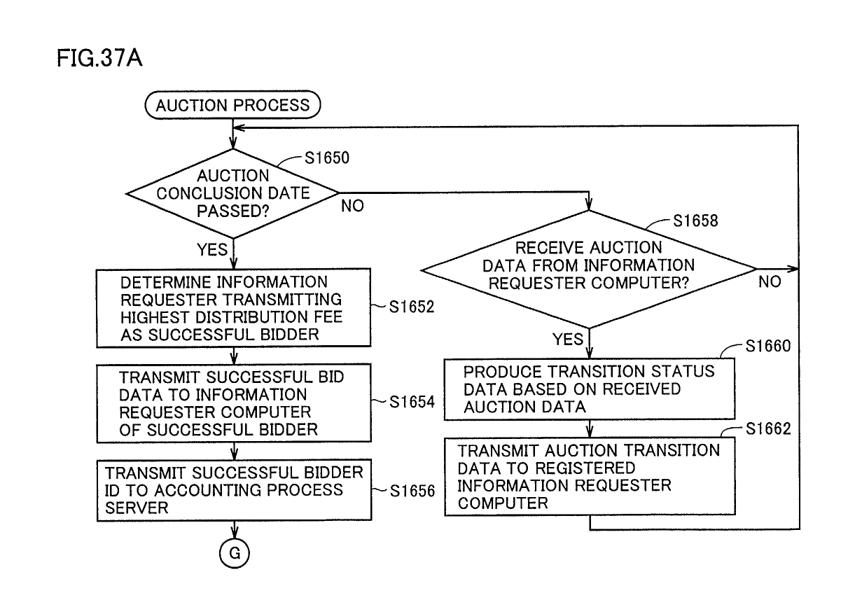

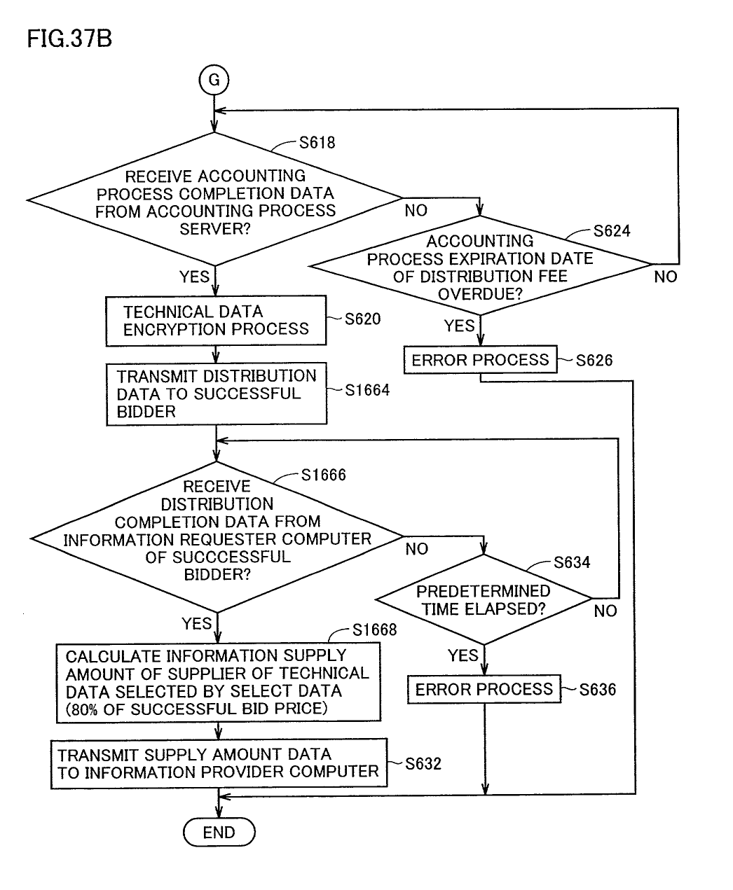

The program executed by server 100 of FIGS. 37A and 37B has a control structure set forth below as to an auction process. In the process of FIG. 37, steps similar to those of FIG. 27 in the previous first embodiment have the same step number allotted. Detailed description thereof will not be repeated here.

At S1650, CPU 120 determines whether the current date has passed the auction conclusion date. When the auction conclusion date has passed (YES at S1650), control proceeds to S1652, otherwise (NO at S1650), control proceeds to S1658.

At S1652, CPU 120 determines the information requester who has transmitted the highest distribution fee as the successful bidder. At S1654, CPU 120 transmits successful bid data (FIG. 33) to information requester computer 300 of the successful bidder. At S1656, CPU 120 transmits the successful bidder ID to accounting process server 400.

At S1658, CPU 120 determines whether auction data (FIG. 31) is received from information requester computer 300. When auction data is received from information requester computer 300 (YES at S1658), control proceeds to S1660, and otherwise (NO at S1658), control returns to S1650.

At S1660, CPU 120 produces transition status data based on the auction data received at S1658. Auction transition data (FIG. 32) is transmitted to information requester computer 300 registered in information requester database (FIG. 29). Then, control returns to S1650. The process from S1658 to S1662 is repeated until the auction conclusion date.

When the successful bidder is determined and the highest distribution fee payment process is carried out by information requester computer 300 of the successful bidder through accounting process server 400, control proceeds to S620 where CPU 120 carries out an encryption process on the technical data. Then, control proceeds to S1664. At S1664, CPU 120 transmits distribution data (FIG. 18) to information requester computer 300 of the successful bidder.

At S1666, CPU 120 determines whether distribution completion data (FIG. 19) is received from information requester computer 300 of the successful bidder. When distribution completion data is received from computer 300 of the successful bidder (YES at S1666), control proceeds to S1668, and otherwise (NO at S1666), control proceeds to S1634.

At S1668, CPU 120 calculates the information supply amount of the supplier of the technical data selected through the select data. Here, the information supply amount is 80% the successful bid price. Then, control proceeds to S632.

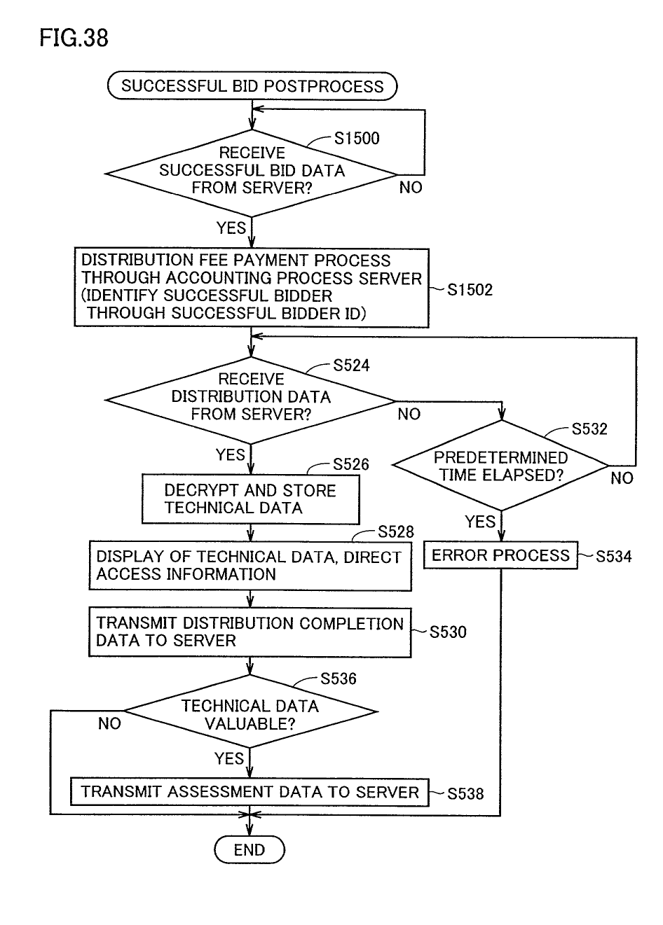

The successful bid postprocess executed by information requester computer 300 of FIG. 38 has a control structure set forth below. Steps in FIG. 38 similar to those of FIG. 26 of the previous first embodiment have the same step numbers allotted. Therefore, detailed description thereof will not be repeated here.

At S1500, information requester computer 300 determines whether successful bid data (FIG. 33) is received from server 100. When successful bid data is received from server 100 (YES at S1500), control proceeds to S1502, and otherwise (NO at S1500), control returns to S1500 to wait for reception of successful bid data from server 100.

At S1502, information requester computer 300 carries out the distribution fee payment process through accounting process server 400. Here, information requester computer 300 transmits the successful bidder ID included in the successful bid data transmitted at S1500 to accounting process server 400. When the successful bidder ID received from server matches the successful bidder ID transmitted from information requester computer 300, accounting process server 400 determines that the user carrying out the distribution fee payment process is the successful bidder. Then, control proceeds to S524.

An operation of the technical information intermediary system according to the above structure and flow charts will be described hereinafter.

[Information Requester Computer: Search Request Operation]

In response to an information requester entering the field of knowledge, search data and the upper limit of the number of retrievals into information requester computer 300 (S500), search request data (FIG. 14) is transmitted to server 100 (S502). When the information requester who has received search resultant data (FIG. 15) from server 100 enters the technical information ID required to be distributed (S508), select data (FIG. 16) is transmitted to server 100 (S510).

[Server Search Operation]

When search request data (FIG. 14) is received from information requester computer 300 (YES at S600), weighting retrieval is effected based on search data (S602). Search resultant data (FIG. 15) is transmitted to information requester computer 300 (S606). Upon reception of select data (FIG. 16) from information requester computer 300 (YES at S608), determination is made whether the information requester who has transmitted the select data is already registered in the information requester database (FIG. 29) (S1600). When the information requester who has transmitted a select data is not registered in the information requester database (NO at S1600), that information requester who has transmitted the select data is registered into the information requester database (S1602). Notification data (FIG. 30) is transmitted to information requester computer 300 of the information requester registered in the information requester database (S1604).

[Server: Auction Operation]

Until the auction conclusion date (NO at S1650), reception of auction data (FIG. 31) from information requester computer 300 (YES at S1658) causes transition status data to be generated (S1660) based on the received auction data. Auction transition data (FIG. 32) is transmitted (S1662) to information requester computer 300 of the information requester registered in the information requester database (FIG. 29).

When the auction conclusion date has passed (YES at S1650), the information requester who has transmitted the highest distribution fee at that time point is determined to be the successful bidder (S1652). The successful bid data (FIG. 33) is transmitted to information requester computer 300 of the successful bidder (S1654).

In the technical information intermediary system, a successful bidder ID to identify the successful bidder is selected and transmitted to accounting process server 400 (S1656).

When information requester computer 300 of the successful bidder has completed the accounting process through accounting process server 400, server 100 receives accounting process end data from accounting process server 400 (YES at S618). Distribution data (FIG. 18) is transmitted to information requester computer 300 of the successful bidder (S1664). When distribution completion data (FIG. 19) is received from information requester computer 300 of the successful bidder (YES at S1666), the information supply amount is calculated for the information provider who has supplied the technical data selected by the select data (S1668). The information supply account calculated here is set to 80% or the like of the successful bidding price.

[Information Requester Computer: Closing Bid Postprocess]

Upon receiving successful bid data (FIG. 33) from server 100 (YES at S1500), information requester computer 300 carries out a distribution fee payment process through accounting process server 400 (S1502). Then, upon receiving distribution data (FIG. 18) from server 100 (YES at S524), the technical data is decrypted (S526) and displayed on the monitor (S528).

In addition to the technical information intermediary system of the previous first embodiment, the technical information intermediary system of the present embodiment causes the header data in the selected technical information, when select data is transmitted to the server from an information requester, to be transmitted to a plurality of information requesters registered in the information register database. An information requester other than the requester who has transmitted the select data is made aware of the presence of technical information of interest other than to his/her own self. Here, the information requester can know the quoting price of the technical information in the market of technical information through the header data representing the summary of technical information and the distribution price. When the information requester receiving the notification data wishes that data to be distributed, auction data including a desired distribution price higher than the current distribution price is transmitted to the server. This operation is repeated until the expiration of the auction conclusion date.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information providing server to provide information requested by a user, comprising:
a storage circuit storing said information and a search term specified by said user to search for said information;
a first search circuit connected to said storage circuit to retrieve a word included in said information;
a first weight storage circuit connected to said first search circuit to store a word retrieved by said first search circuit and a weight of said word;
a first computation circuit connected to said storage circuit and said first weight circuit to retrieve a word matching said search term from words included in said information, and compute a level of coincidence between said information and said search term based on the weight of the word matching said search term;
a determination circuit connected to said first computation circuit to determine information requested by said user based on said level of coincidence; and
a supply circuit connected to said determination circuit to supply said user with said determined information.

2. The information providing server according to claim 1, further comprising:
a second search circuit connected to said storage circuit to retrieve a compound term included in said information; and
a second weight storage circuit connected to said first weight storage circuit and said second search circuit to store a compound term retrieved by said second search circuit and a weight of said compound term,
wherein said compound term forms another new one word with a plurality of words connected,
said compound term applied with weight so that a level of coincidence is computed different from the level of coincidence computed based on weights of words included in said compound term;
said information providing server further comprising a second computation circuit connected to said storage circuit and said second weight storage circuit to retrieve a compound term matching said search term from compound terms included in said information, and computing a level of coincidence between said information and said search term based on the weight of said compound term matching said search term,
wherein said determination circuit comprises a circuit determining information requested by said user based on the level of coincidence computed by said first computation circuit and the level of coincidence computed by said second computation circuit.

3. The information providing server according to claim 2, wherein a level of coincidence higher than the level of coincidence computed based on weights of words included in said compound term is computed by the weight of said compound term stored in said second weight storage circuit.

4. The information providing server according to claim 2, wherein said weight of a compound term stored in said second weight storage circuit is greater than a sum of weights of words included in said compound term.

5. The information providing server according to claim 1, wherein said information includes data representing said information, and summary data representing a summary of said information,
said information providing server further comprising:
a communication circuit communicating with said server; and
a transmission circuit connected to said determination circuit and said communication circuit to transmit said summary data included in said determined information to a plurality of said users,
wherein a user receiving said summary data determines whether said determined information is required or not based on said summary data, and the user who has determined that said determined information is required transmits request data to said server,
said information supply server further comprising a reception circuit connected to said communication circuit to receive said request data from said user,
wherein said supply circuit includes a circuit supplying said user who has transmitted the request data with said determined information.

6. The information providing server according to claim 5, further comprising a control circuit connected to said supply circuit to control said supply circuit so that said determined information is provided to said server when a predetermined condition is met.

7. The information providing server according to claim 6, wherein said request data includes fee data representing a predetermined amount to be paid by said user for supply of said determination circuit,
said information providing server further comprising a user determination circuit connected to said communication circuit to determine one user who has transmitted a highest amount from said plurality of users,
wherein said predetermined condition is the condition that said one user has paid said highest amount.

8. An information providing server to provide information requested by a user, comprising:
storage means for storing said information and a search term specified by said user to search for said information;
first search means connected to said storage means for retrieving a word included in said information;
first weight storage means connected to said first search means for storing a word retrieved by said first search means and a weight of said word;
first computation means connected to said storage means and said first weight means for retrieving a word matching said search term from words included in said information, and computing a level of coincidence between said information and said search term based on the weight of the word matching said search term;
determination means connected to said first computation means for determining information requested by said user based on said level of coincidence; and
supply means connected to said determination means for supplying said user with said determined information.

9. The information providing server according to claim 8, further comprising:
second search means connected to said storage means for retrieving a compound term included in said information; and
second weight storage means connected to said first weight storage means and said second search means for storing a compound term retrieved by said second search means and a weight of said compound term,
wherein said compound term forms another new one word with a plurality of words connected,
said compound term applied with weight so that a level of coincidence is computed different from the level of coincidence computed based on weights of words included in said compound term;
said information providing server further comprising second computation means connected to said storage means and said second weight storage means for retrieving a compound term matching said search term from compound terms included in said information, and computing a level of coincidence between said information and said search term based on the weight of said compound term matching said search term,
wherein said determination means comprises means determining information requested by said user based on the level of coincidence computed by said first computation means and the level of coincidence computed by said second computation means.

10. The information providing server according to claim 9, wherein a level of coincidence higher than the level of coincidence computed based on weights of words included in said compound term is computed by the weight of said compound term stored in said second weight storage means.

11. The information providing server according to claim 9, wherein said weight of a compound term stored in said second weight storage means is greater than a sum of weights of words included in said compound term.

12. The information providing server according to claim 8, wherein said information includes data representing said information, and summary data representing a summary of said information,
said information providing server further comprising:
communication means for communicating with said server; and
transmission means connected to said determination means and said communication means for transmitting said summary data included in said determined information to a plurality of said users,
wherein a user receiving said summary data determines whether said determined information is required or not based on said summary data, and the user who has determined that said determined information is required transmits request data to said server,
said information supply server further comprising reception means connected to said communication means for receiving said request data from said user,
wherein said supply means includes means for supplying said determined information to said user who has transmitted the request data.

13. The information providing server according to claim 12, further comprising control means connected to said supply means for controlling said supply means so that said determined information is provided to said server when a predetermined condition is met.

14. The information providing server according to claim 13, wherein said request data includes fee data representing a predetermined amount to be paid by said user for supply of said determination means,
said information providing server further comprising user determination means connected to said communication means for determining one user who has transmitted a highest amount from said plurality of users,
wherein said predetermined condition is the condition that said one user has paid said highest amount.

15. A method of providing information to a user who requests information, comprising the steps of:
preparing said information and a search term specified by said user to search for said information;
retrieving a word included in said information;
storing a word retrieved at said step of retrieving a word and a weight of said word;
retrieving a word matching said search term from words included in said information, and computing a level of coincidence between said information and said search term based on a weight of a word matching said search term;
determining said information requested by said user based on said level of coincidence; and
supplying said user with said determined information.

16. The information providing method according to claim 15, further comprising the steps of:
retrieving a compound term included in said information; and
storing said retrieved compound term and a weight of said compound term;
wherein said compound term forms another new one word with a plurality of words connected,
said compound term applied with a weight so that a level of coincidence is computed differing from the level of coincidence computed based on weights of words included in said compound term,
said information providing method further comprising the step of retrieving a compound term matching said search term from compound terms included in said information, and computing a level of coincidence between said information and said search term based on the weight of said compound term matching said search term,
wherein said step of determining information includes the step of determining information required by said user based on the level of coincidence computed at said step of computing a level of coincidence based on the weight of words, and the level of coincidence computed at said step of computing a level of coincidence based on the weight of compound terms.

17. The information providing method according to claim 16, wherein a level of coincidence higher than the level of coincidence computed based on the weight of words included in said compound term is computed by weights of said compound terms.

18. The information supply method according to claim 16, wherein the weight of said compound term is greater than a sum of weights of words included in said compound term.

19. The information providing method according to claim 15, wherein said information includes data representing said information, and summary data representing a summary of said information,
said information providing method further comprising the step of transmitting said summary data included in said determined information to a plurality of said users,
wherein a user receiving said summary data determines whether said determined information is required based on said summary data, and the user who has determined that said determination information is required transmits request data,
said information providing method further comprising the step of receiving said request data from said user,
wherein said step of supplying information includes the step of supplying the user who has transmitted said request data with said determined information.

20. The information providing method according to claim 19, further comprising the step of executing said step of supplying said information when a predetermined condition is met.
